(19) United States
(12) Patent Application Publication
(10) Pub. No.: US 2016/0042120 A1
(43) Pub. Date: Feb. 11, 2016

(54) METHODS FOR DECONVOLUTION OF MIXED CELL POPULATIONS USING GENE EXPRESSION DATA

(71) Applicant: NanoString Technologies, Inc., Seattle, WA (US)

(72) Inventor: Patrick John Danaher, Seattle, WA (US)

(21) Appl. No.: 14/817,260

(22) Filed: Aug. 4, 2015

Related U.S. Application Data
(60) Provisional application No. 62/035,019, filed on Aug. 8, 2014.

(51) Int. Cl. G06F 19/20; G06F 19/24; C40B 30/02

(52) U.S. Cl. CPC G06F 19/20; C40B 30/02; G06F 19/24

(57) ABSTRACT

Body fluid identification by mRNA profiling may allow extraction of contextual ‘activity level’ information from forensic samples. Accordingly, a prototype multiplex digital gene expression method for forensic body fluid/tissue identification is provided, based upon solution hybridization of color-coded (e.g., NanoString®) probes. For example, a model for gene expression in a sample from a single body fluid is provided and extended to mixtures of body fluids. A calculation of maximum likelihood estimates of body fluid quantities in a sample is performed, and use of likelihood ratios to test for the presence of each body fluid in a sample is described. A process/algorithm is described and, unlike conventional algorithms for detecting tissues and cells, may allow for zero false-positive fluid identifications across a plurality of samples. Such a protocol may facilitate routine use of mRNA profiling in casework (e.g., forensic) laboratories that previously has not been as reliable.

### CROSS-REFERENCE TO RELATED APPLICATIONS

This application claims the benefit of U.S. Provisional Application No. 62/035,019, filed Aug. 8, 2014. The contents of the aforementioned patent application are incorporated herein by reference in their entireties.

### BACKGROUND OF THE INVENTION

Biological samples often comprise mixtures of different types of substances (e.g., different types of cells, such as tumor cells and healthy cells, mixtures of multiple microbes, mixtures of different biological fluids, mixtures of immune cells, and/or the like). Deconvolution is generally used to estimate proportions of substances in a given sample based on known gene expression patterns within the substances, and/or to estimate the average gene expression profile within each type of substance given a known substance ratio in a given sample.

Conventional deconvolution methods often assume an additive model for sample mixture data: E(Y)=XB, where Y is an n*p matrix of gene expression in n samples and p genes, X is a p*K matrix of prototypical gene expression of the p genes in K cell types, and B is an n*K matrix of the quantities of each cell type in each sample. The additive model usually assumes that the amount of a gene transcript in a sample is the sum of the amount of the transcript in each of the sample's cell subpopulations. Additionally, by using an additive model, if a previous experiment allows estimation of the cell types' prototypical gene expression profiles X, then it is possible to estimate the matrix of cell type quantities B from X and Y. Alternatively, if B is known (e.g., by running the sample through a cell sorter before expression profiling), then the average expression profile of each cell type may be estimated. Through the introduction of prior information like the identities of genes expected to be unique to one sample type and constraints on parameters to ensure identifiability, some scientists have traditionally used this model to estimate B and X simultaneously.

The additive model, however, is problematic in a number of ways. For example, gene expression data is often log-transformed before analysis (save for qPCR data, which already exists on the log scale), and differential expression is generally measured in fold-changes, not additive increases. By transforming the data and/or utilizing it in such a manner as to incorporate it into an additive model, accuracy may be lost, resulting in incorrect results (e.g., false positives and/or false negatives of substances in a sample, or in inefficient estimates of mixing proportions and/or cell type gene expression profiles).

### SUMMARY OF THE INVENTION

The methods disclosed herein describe a deconvolution method using both an additive model and a log-based calculation for more accurate gene expression calculations. This facility would be expected to be of significant benefit when analyzing sample mixtures, including but not limited to body fluid mixtures encountered in forensic analysis, and/or like sample mixtures. Specifically, described herein are statistical methods using the log or multiplicative scale and an additive model, which can calculate quantities of given fluids in a sample based on the gene expression of various targeted genes in the sample.

In some embodiments, a method for forensic biological sample identification may comprise obtaining at least one biological sample for analysis, extracting a total RNA from the biological sample, hybridizing the total RNA with at least one probe, in at least one assay, and analyzing the at least one assay using a multiplex codeset. In some implementations analyzing the assay may comprise determining a set of genes to quantify in the sample, modelling gene expression of each gene in the set of genes via generating a gene expression log function for each gene in the set of genes, and generating a maximum likelihood estimation of an amount of a biological substance in the biological sample based on the modelled gene expression of each gene in the set of genes.

In some embodiments, a method for estimating the presence of substances in at least one biological sample may comprise determining a set of biological substances to detect within a biological sample, modelling the expression of each gene in a set of unique genes in the biological substance for each biological substance in the set of biological substances, and generating an expected gene proportion model using the modelled expression of each gene in the set of unique genes in the biological substance. In some embodiments the method may further comprise generating a substance model containing a quantity of each biological substance in the set of biological substances within the biological sample, generating an expected gene expression model via using the expected gene proportion model and the substance model, and estimating gene expressing in the biological sample using the expected gene expression model. Further, the method may comprise generating an estimated sample profile based on a Maximum Likelihood Estimate of each biological substance in the set of biological substances using the estimated gene expression in the biological, calculating a likelihood ratio for each biological substance in the set of biological substances, the likelihood ratio indicating how likely the biological substance is contained in the biological sample, and determining whether each biological substance in the set of biological substances is in the biological sample based on the calculated likelihood ratio.

In some embodiments, the apparatuses, methods, and systems described herein can identify common forensically relevant body fluids and/or a variety of substances potentially present in a variety of samples, by multiplex solution hybridization of barcode probes to specific mRNA targets using a five minute direct lysis protocol. This simplified protocol with minimal hands-on requirement may facilitate routine use of mRNA profiling in casework laboratories. In contrast to most gene expression-based classifiers, the algorithm may not involve training a machine learning algorithm to optimize the ability to call samples correctly; rather, it may define a biologically reasonable model of gene expression in body fluid samples and use that model to evaluate the strength of evidence a sample provides for the presence of a particular fluid. This algorithm may allow the calculation of log-likelihoods for detection of each fluid type, making the algorithm's results more defensible in courtroom settings.

A further benefit of approaches according to some embodiments of the present disclosure is that it allows evaluation of the algorithm on all samples, including those used in training as the algorithm is based on an a priori model of gene expression in body fluid mixtures, and since its parameters may be estimated without regard to model performance, the algorithm may only minimally overfit the training data.

In some implementations, the apparatuses, methods, and systems described herein may be applied to gene expression data, protein data, metabolite data, and miRNA expression data, and/or any other data with log-scale variability. In some embodiments, the output of the methods described here can be used in classification, clustering and/or other machine learning problems. In some embodiments, the methods described here can be used to test for differential expression of a gene between samples or classes. In some embodiments, the methods described here can be used to test for the expression of a gene in a sample type.

In preferred embodiments, NanoString Technologies®'s nCounter® systems and methods are used. Probes and methods for binding and identifying specific mRNA targets have been described in, e.g., US2003/0013091, US2007/0166708, US2010/0015607, US2010/0261026, US2010/0262374, US2010/0112710, US2010/0047924, and US2014/0371088, each of which is incorporated herein by reference in its entirety.

Any aspect or embodiment described herein can be combined with any other aspect or embodiment as disclosed herein. While the disclosure has been described in conjunction with the detailed description thereof, the foregoing description is intended to illustrate and not limit the scope of the disclosure, which is defined by the scope of the appended claims. Other aspects, advantages, and modifications are within the scope of the following claims.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 depicts exemplary ROC curves showing the algorithm's True Positive Rate (TPR) and False Positive Rate (FPR) for each tissue in some example embodiments.

FIG. 2 depicts exemplary performance results of the algorithm in five mixture samples in some example embodiments.

FIG. 3 depicts a logic flow diagram illustrating calculating a sample's composition in some example embodiments.

FIG. 4 depicts comparison of exemplary performance results for samples prepared according to the direct lysis protocol, disclosed herein, and for samples prepared according to the purification protocol, disclosed herein.

FIG. 5 depicts exemplary performance results of the algorithm in 91 single-source samples in some example embodiments.

FIG. 6 depicts exemplary performance results of the algorithm in 23 single-source, adequate RNA samples in some example embodiments.

FIGS. 7A-F depict a series of plots showing gene expression profiles of different samples of the same fluid type. FIG. 7A shows the consistency of blood (BD) gene expression profiles. FIG. 7B shows the consistency of semen (SE) gene expression profiles.

FIG. 7C shows the consistency of saliva (SA) gene expression profiles. FIG. 7D shows the consistency of vaginal secretion (VS) gene expression profiles. FIG. 7E shows the consistency of menstrual blood (MB) gene expression profiles. FIG. 7F shows the consistency of skin (SK) gene expression profiles. Each point is a gene; genes are colored by their characteristic fluid type. Nominal blood genes are red, semen genes are blue, saliva genes are green, vaginal secretion genes are yellow, menstrual blood genes are pink, skin genes are purple, and housekeeper genes which appear in all cell types are black. Blood (BD).

FIG. 8 plots the average gene expression profile of each fluid against each other fluid. Genes are colored as in in FIGS. 7A to 7F.

### DETAILED DESCRIPTION OF THE INVENTION

In some embodiments, statistical analysis may be performed on a sample including at least one identifiable substance, in order to determine the composition of the sample and the gene expression within the sample. In some embodiments, exemplary cases may include forensic samples containing a plurality of substances (e.g., skin, venous blood, vaginal secretion, saliva, menstrual blood, semen, and bio-particles), and/or any sample (e.g., a biological sample) containing a plurality of substances (e.g., biological substances), which may need to be identified and/or quantified, e.g., using the gene expression of targeted genes known to be in each of the substances.

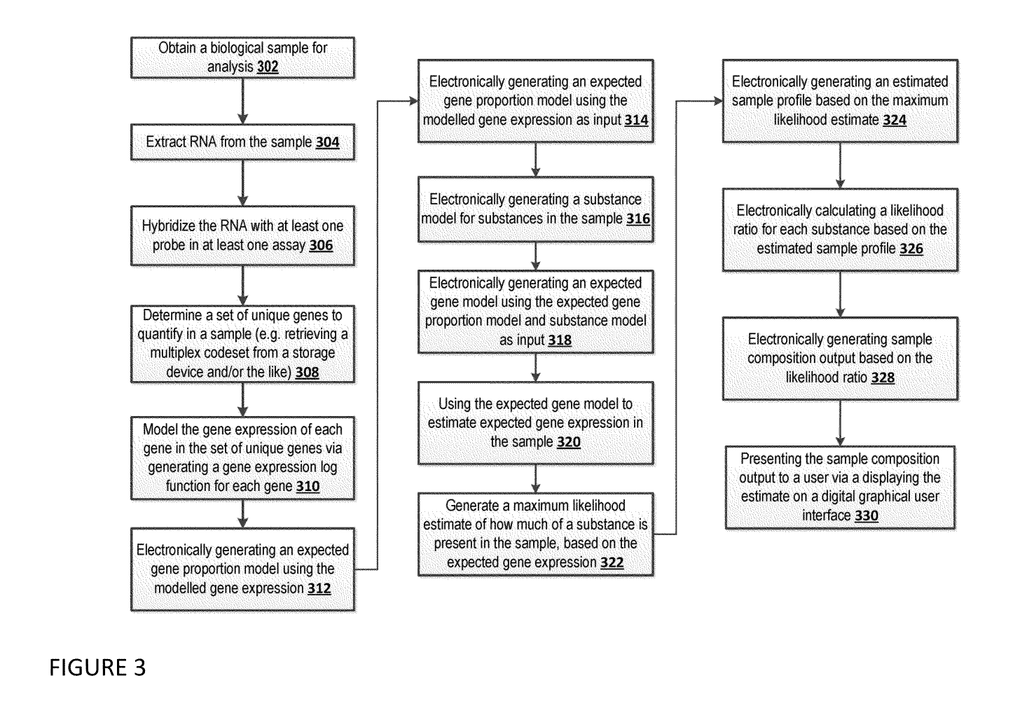

In some embodiments, referring to FIG. 3, one may obtain a sample 302 (e.g., a biological sample comprising a plurality of substances), and a total RNA amount may be extracted from the sample 304 using at least one of direct lysis with purification and direct lysis without purification. In some implementations, direct lysis may include lysing the sample at 75° C. for a specified period, e.g., approximately five minutes. The RNA may be hybridized 306 with probes (e.g., reporter probes and capture probes) specified by a user or computer-generated multiplex codeset designed particularly for the sample and/or the substances suspected of being within the sample. For example, for a forensics tissue sample with any of the above forensic substances, the multiplex codeset may specify a plurality of unique genes for each substance 308, such as venous blood genes ALAS2, ALOXSAP, AM1CA1, ANK1, AQP9, ARHGAP26, C1QR1, C5R1, CASP2, CD3G, GYPA, HBA, HBB, HMBS (PBGD), MNDA, NCFS2, and SPTB, menstrual blood genes LEFTY2, MMPI, MMP10; and MMP11, saliva genes HTN3, MUC7, S. mutans 16S, S. mutans proC, S. mutans relA, S. mutans rplA, S. mutans rpoB, S. mutans rpoS, S. salivarius 16S, S. salivarius proC, S. salivarius relA, S. salivarius rplA, S. salivarius rpoB, S. salivarius rpoS, SMR3B, and STATH, semen genes IZUMO1, MSP, PSA (KLK3), PRM1, PRM2, SEMG1, SEMG2, and TGM4, skin genes CCL27, IL1F7, KRT9, LCE1C, and LCE2D, vaginal secretion genes CYP2A7, CYP2B7P1, DKK4, FUT6, IL19, MYOZ1, and NOXO1, and reference genes B2M, COX1, HPRT1, PGK1, PPIH, S15, TCEA1, TFRC, UBC, and UBE2D2. The multiplex codeset may also specify a plurality of probes and/or similar substances for tracking said exemplary genes. Similar multiplex codesets may be generated for any number of genes in any number of substances, for various types of samples. In some implementations, multiplex codesets may include at least one of positive control probes and negative control probes, e.g., in order to both detect genes (e.g., positive control probes) and to assess background noise in the analysis of the sample (e.g., negative control probes).

### Statistical Methods

Three exemplary properties of casework samples include: they often (i) comprise mixtures of two or more fluids, (ii) are limited in size and (iii) could be either partially or highly degraded. Thus, one exemplary approach to dealing with casework samples is as follows:
Model the probability distribution of gene expression in body fluid samples.
Use the model to calculate the Maximum Likelihood Estimate (MLE) for the levels of each body fluid in a sample and to calculate the log-likelihood of a sample's profile given the estimated levels of each fluid.
Construct a likelihood ratio comparing the likelihood of a given sample's profile with and without the presence of a given fluid. If a sample's profile is far more likely when a specific fluid is included in the model, then we may conclude the fluid is present in the sample.

### Modeling Gene Expression in Mixture Samples

In some embodiments, gene expression may be best modeled on the log (multiplicative) scale. For example, a doubling of a gene's expression level may be generally considered a change comparable in magnitude to a halving of its expression level, and a gene increasing from 200 to 400 mRNA transcripts is as meaningful a difference in gene expression as a gene increasing from 2000 to 4000 counts. However, the mathematics of mixtures may be additive. For example, if a sample is half blood and half saliva, a gene's cumulative expression level may result from the summation of its expression levels in each tissue sample. Therefore, the contributions of each fluid to a mixture may be modeled on a linear scale, but discrepancies between observed and predicted expression may be measured on the log scale.

In some embodiments, a model for gene expression in a sample from a single fluid may be defined and then extended to mixtures of fluids. In some implementations, various models may be implemented, generated, stored, and/or utilized on a computing device. From there, a calculation of maximum likelihood estimates (MLEs) of fluid quantities in a sample, and the use of likelihood ratios to test for the presence of a fluid in a sample may be described.

Model for Gene Expression in a Sample from a Single Body Fluid

In some embodiments, each gene represents a given proportion of total gene expression in each fluid. For example, in an average blood sample one might expect 15% of total RNA to be HBB, 1% to be ALAS1, etc. In some embodiments these may be referred to as expected proportions X_{HBB}, X_{ALAS1}, and/or the like. Therefore in a given blood sample, the vector of expected gene expression may be β(X_{HBB}, X_{ALAS1}, . . . )^{T}, where β is the total amount of RNA in the sample.

Due to both biological and technical noise, actual expression may vary around its expectation. Per the multiplicative nature behavior of gene expression, the variability may be modelled as arising from a log-normal distribution, wherein each gene may be assumed to be equally variable. A single gene's expression in a sample can then be modeled 310 using the following exemplary function:

log(y_{HBB})˜N(log(X_{HBB}β),σ²),

where y_{HBB} may be the expression of HBB in the sample, and σ² may be the variance (on the log scale) of HBB's expression around its expectation.

### Model for Gene Expression in Mixtures of Body Fluids

The model for mixtures may be derived from the model for single-fluid samples 312. For notation purposes, matrices may be represented with bold, uppercase letters, vectors with bold, lowercase letters, and scalars with lowercase letters. Samples may be indexed iε (1, . . . , n), genes jε (1, . . . , p), and tissues kε (1, . . . , K). The gene expression profile for a given sample may be yᵢ=(yᵢ₁, . . . , yᵢₚ)^{T}, where yᵢⱼ is the expression of gene j in sample i. βᵢₖ may be the amount of fluid k in sample i, and βᵢ=(βᵢ₁, . . . , β_{iK}) may be the vector of the amounts of all the fluids in sample i 316. Finally, a matrix X may be defined to represent the expected proportion of each gene j in each fluid type k 314, with xⱼₖ being the element in the j^{th} row and the k^{th} column of X, representing the expected proportion of gene j in samples from fluid k. In some implementations, the covariance matrix of the p genes' log-transformed expression levels may be notated as Σ. Additionally, the Lₚ norm of a matrix A may be represented as ∥A∥_{P} (e.g., wherein p=2 in some implementations).

Referring to FIG. 3, assuming the number of mRNA molecules in mixtures of fluids may be a sum of the number of mRNA molecules in each component of the mixture, one can write the expected counts of gene j in sample I:

E(yᵢⱼ)=Σₖ₌₁^{K}βᵢₖxⱼₖ,

and the expression for the sample's entire expected gene expression vector may be, in some embodiments 320:

E(yᵢ)=Xβᵢ.

Again, assuming the variability of gene expression occurs on the log scale, gene expression in a sample may be modelled as 318:

log(yᵢ)˜N(log(Xβᵢ),σ²I),

where I is the identity matrix and σ² is the common variance (on the log scale) of all genes. (Note that if E(yᵢ)=Xβᵢ, then E(log(yᵢ))≠log(Xβᵢ). However, under the values considered in this application, E(log(yᵢ)) very closely approximates log(Xβᵢ). In some embodiments, if the data necessary to fully estimate the genes' covariance matrix is missing and/or absent, one may approximate it with σ²I.

Before applying the above model for gene expression in body fluids, one may estimate two parameters: X, e.g., the matrix of expected proportions of gene expression, and σ², e.g., the variance of gene expression. Estimation of the X matrix is described above. σ², the variance on the log scale common to all genes, may be estimated as the average variance of each gene in each fluid. In some implementations, X may be scaled to have columns summing to 1; in other implementations, may be scaled instead of X, neither matrix may be scaled, and/or one or both of the matrices may be scaled to a variety of different values.

### Maximum Likelihood Estimation of the Amounts of Each Fluid in a Sample

Under the assumptions that log gene expression is normally distributed around the log of its expectation and that each gene is equally variable, the MLE 322 for βᵢ can be calculated as follows:

$${\hat{β}}_{i} = arg {min}_{β} {‖ log ( {y}_{i} ) - log ( X {β}_{i} ) ‖}_{2}^{2} s . t . β \geq 0 ,$$

i.e., \hat{β}ᵢ minimizes the sum of squared errors on the log scale between the observed gene expression yᵢ and the predicted gene expression Xβ, subject to the constraint that all the elements of β are non-negative (a sample cannot have negative amounts of a fluid). If a closed-form solution to this expression does not exist, numerical methods may be used to optimize it (Byrd et al, SIAM J. Scientific Computing, 1995). The expression is not convex in β; however, its estimates may be reasonably robust to differing initial conditions, returning similar estimates with very similar log-likelihoods.

In some embodiments where the algorithm may risk overexerting itself trying to fit gene expression values in the background of the assay, subsequent layers of complexity may be added to the model. For example, in addition to fitting β terms for each fluid, a β may be added for background, with a corresponding column in the X matrix with equal weights on all genes. The background β term may be further constrained to contribute no more than some number (e.g., 15 counts) to each gene. For the same reason, all gene expression values may be truncated at 5 counts in order to derive a reasonable estimate of the average background counts 324.

### Using Likelihood Ratios to Test the Presence of Fluids

In any given sample yᵢ, one may determine which fluids are present. In some embodiments, this may involve testing whether each element of βᵢ equals 0. One exemplary approach is to calculate the likelihood of the data under the MLE \hat{β}ᵢ and under a constrained MLE \hat{β}_{i,-j} 326 with the βᵢⱼ term corresponding to the tissue in question forced to 0. The likelihood ratio under the full and constrained MLEs may summarize the evidence for the presence of the tissue of question.

Calculation of a log likelihood for the data given a MLE may involve a log gene expression which is normally distributed around the log of the predicted gene expression. Then up to a constant, the log-likelihood of yᵢ given \hat{β}ᵢ is:

$$log lik ( {y}_{i} \vert {\hat{β}}_{i} ) = - \frac{1}{2} log ( det ( {σ}^{2} I ) ) - \frac{1}{2} {( log ( {y}_{i} ) - log ( X {\hat{β}}_{i} ) )}^{T} {σ}^{- 2} I ( log ( {y}_{i} ) - log ( X {\hat{β}}_{i} ) ) .$$

To test whether fluid j is present in sample i, we evaluate the above expression using yᵢ and \hat{β}ᵢ and again using yᵢ and the constrained MLE \hat{β}_{i,-j}, and we calculate a likelihood ratio. The resulting value derived from the likelihood ratio may indicate what the sample composition is expected to include 328. In some implementations, all of the above calculations may be processed on an electronic computing device. In some implementations the electronic computing device may then present the sample composition output to a user 330, e.g., via a display module operatively coupled to the electronic computing device and configured to display the output in a digital graphical user interface, and/or the like.

In some implementations, the electronic computing device may determine and implement confidence intervals around estimated X or β values, e.g., based on the log likelihood ratio between the estimated X or β matrices and an arbitrary X or β matrix, and/or the like.

### Estimating Proportions of Substances in a Sample Based on Estimated Gene Expression

In some implementations, an electronic computing device may calculate the proportion of each substance (e.g., cell types, and/or the like) in a sample (e.g., in a tissue sample, and/or the like), e.g., using a penalty value and/or like constant. The estimation may be calculated using a function resembling the following exemplary function:

S=argmin_β{∥(log(y)−log(Xβ))^{T}Σ⁻¹(log(y)−log(Xβ∥_{P}+Penalty(β)}

wherein S=the proportions of the substances in the sample, and wherein the function is subject to the constraint that the elements in β are all non-negative, and wherein Penalty(β) represents a further penalty on the elements of β (including but not limited to an “elastic net” penalty, the Dantzig selector, an Lp penalty, a group or fused lasso penalty if appropriate, any combination thereof, and/or the like). In some implementations, may be a K*1 matrix.

### Estimating Gene Expression Profile of Each Substance Based on Proportions of Substances in a Sample

In some implementations, the above equation for estimating proportions of substances in a sample, may be modified by an electronic computing device such that the electronic computing device can also estimate the gene expression profile of each substance estimated to be in the sample. For example, for a gene j, its expression may be written in n samples as y′=(y_{i,j}, . . . , yₙⱼ)^{T}. The expected expression of gene j in each substance may be represented as x′=X_{j,1}, . . . , X_{j,K})^{T}, wherein X is defined as a matrix of expected proportions of gene expression, similar to the above equations. Let (β^{T})_{n*K} be the matrix of the estimated proportions of each of the K cell types in the n samples. In some implementations, (β^{T})_{n*K} may be a K*n matrix due to the inclusion of multiple samples.

Using the above values, x′ may be calculated using a function resembling the following exemplary function:

GE=argmin_{—}x′{∥(log(y′)−log(β^{T}x′))^{T}Σ⁻¹(log(y′)−log(β^{r}x′))∥_{P}+Penalty(x′)}

wherein GE=the gene expression profile in each substance, and wherein the function is subject to the constraint that the elements of x′ are all non-negative.

### Further Applications

In some implementations, if X and β are unknown, GE and S may be combined in order to estimate both matrices jointly. For example, beginning with the most reasonable estimate possible for either X or β, one may iterate between estimating X from β, and vice-versa, until the estimates converge at values for both matrices.

In some implementations, if one column of X is unknown and the other columns are known (e.g., when cancer cells are mixed with normal tissue, due to gene expression in cancer being much more variable that gene expression in normal cells), the statistical method may estimate β using the best available estimate of the X matrix (e.g., if cancer cells and normal cells are being analyzed, one may use the average gene expression profile of cancer cells for the unknown column of X). The expression in the substance with the uncertain expression profile (e.g., the unknown column of X) may then be estimated using a function resembling the following exemplary function:

y−X₋ₖβ₋ₖ

wherein X₋ₖ is the X matrix without the uncertain column, and wherein β₋ₖ is the β vector without the term for the uncertain substance type.

In some implementations, one also may be able to estimate a covariance matrix Σ for each substance. Then, using substance-specific covariance matrices Σ₁, . . . , Σₖ, the statistical method may be able to refine a global covariance matrix Σ based on the substance-specific matrices. For example, after choosing an appropriate global covariance matrix Σ (e.g., based on maximum likelihood estimation, penalized maximum likelihood estimation, the empirical covariance matrix and/or the like) in order to estimate β, an electronic computing device may use the estimated β and Σ₁, . . . , Σₖ to determine a new covariance matrix Σ for the sample. The electronic computing device may continue to estimate β and use it and the substance-specific matrices in order to calculate a covariance matrix Σ until convergence, and/or the like.

As used in this Specification and the appended claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 00.5%, 0.1%, 0.05%, or 0.01% of the stated value. Unless otherwise clear from the context, all numerical values provided herein are modified by the term “about.”

Unless defined otherwise, all technical and scientific terms used herein have the same meaning as commonly understood by one of ordinary skill in the art to which the invention pertains. Although other probes, compositions, methods, and kits similar, or equivalent, to those described herein can be used in the practice of the present invention, the preferred materials and methods are described herein. It is to be understood that the terminology used herein is for the purpose of describing particular embodiments only, and is not intended to be limiting.

### Examples

### Selection of mRNA Biomarkers

In some embodiments, a ‘Codeset’ (e.g., a multiplex codeset) of 57 body fluid/tissue specific plus 10 housekeeping gene controls (TABLE 1), which is well within the 800 target technological capability of the system, may be utilized. To take advantage of the high multiplex capability of the system, biomarkers that have been demonstrated to be highly specific to a particular body fluid (e.g., PRM2 and SEMG1 for semen) may be included, as well as some that have shown a lesser degree of tissue specificity (e.g., MYOZ1 for vaginal secretions and MUC7 for saliva). See, also TABLE 2 and TABLE 3.

TABLE 1
Body Fluid Specific and Housekeeping Genes in the NanoString ®
Custom Codeset

| Gene | Body Fluid Target |
|---|---|
| ALAS2 | Blood |
| ALOX5AP | Blood |
| AM1CA1 | Blood |
| ANK1 | Blood |
| AQP9 | Blood |
| ARHGAP26 | Blood |
| C1QR1 | Blood |
| C5R1 | Blood |
| CASP2 | Blood |
| CD3G | Blood |
| GYPA | Blood |
| HBA, | Blood |
| HBB | Blood |
| HMBS (PBGD) | Blood |
| MNDA | Blood |
| NCFS2 | Blood |
| SPTB | Blood |
| LEFTY2 | Menstrual Blood |
| MMP7 | Menstrual Blood |
| MMP10 | Menstrual Blood |
| MMP11 | Menstrual Blood |
| HTN3 | Saliva |
| MUC7 | Saliva |
| S. mutans 16S | Saliva |
| S. mutans proC | Saliva |
| S. mutans relA | Saliva |
| S. mutans rplA | Saliva |
| S. mutans rpoB | Saliva |
| S. mutans rpoS | Saliva |
| S. salivarius 16S | Saliva |
| S. salivarius proC | Saliva |
| S. salivarius relA | Saliva |
| S. salivarius rplA | Saliva |
| S. salivarius rpoB | Saliva |
| S. salivarius rpoS | Saliva |
| SMR3B | Saliva |
| STATH | Saliva |
| IZUMO1 | Semen |
| MSP | Semen |
| PSA (KLK3) | Semen |
| PRM1 | Semen |
| PRM2 | Semen |
| SEMG1 | Semen |
| SEMG2 | Semen |
| TGM4 | Semen |
| CCL27 | skin |
| IL1F7 | skin |
| KRT9 | skin |
| LCE1C | skin |
| LCE2D | skin |
| CYP2A7 | vaginal |
| CYP2B7P1 | vaginal |
| DKK4 | vaginal |
| FUT6 | vaginal |
| IL19 | vaginal |
| MYOZ1 | vaginal |
| NOXO1 | vaginal |
| B2M | Reference Gene |
| COX1 | Reference Gene |
| HPRT1 | Reference Gene |
| PGK1 | Reference Gene |
| PPIH | Reference Gene |
| S15 | Reference Gene |
| TCEA1 | Reference Gene |
| TFRC | Reference Gene |
| UBC | Reference Gene |
| UBE2D2 | Reference Gene |

TABLE 2
List of Samples Tested

| Sample Type | N | Description |
|---|---|---|
| Blood | 14 | |
| Organic Extraction | 7 | Blood stain on cotton cloth (−47° C. storage after drying) |
| | 1 | Environmental (outside (FL) - heat, sunlight, humidity, rain |
| | | (1 month) |
| | 1 | Environmental (outside (FL) - heat, sunlight, humidity, covered |
| | | (3 days) |
| Direct Lysis (RLT) | 5 | Blood stain on cotton cloth (−47° C. storage after drying) |
| Semen | 17 | |
| Organic Extraction | 7 | Dried on cotton swabs (−47° C. storage after drying) |
| | 2 | Environmental (outside (FL) - heat, sunlight, humidity, covered |
| | | (1 week) |
| | 3 | Sensitivity: 25 ng, 12.5 ng, 6.25 ng (input achieved by use of 5 μL of |
| | | extract) |
| Direct Lysis (RLT) | 5 | Dried on cotton swabs (−47° C. storage after drying) |
| Saliva | 17 | |
| Organic Extraction | 7 | Dried buccal sample on cotton swabs (−47° C. storage after drying) |
| | 1 | Environmental (outside (FL) - heat, sunlight, humidity, rain (1 week) |
| | 1 | Environmental (outside (FL) - heat, sunlight, humidity, covered |
| | | (1 month) |
| | 3 | Sensitivity: 25 ng, 12.5 ng, 6.25 ng (input achieved by use of 5 μL of |
| | | extract) |
| Direct Lysis (RLT) | 5 | Dried buccal sample on cotton swabs (−47° C. storage after drying) |
| Vaginal Secretions | 10 | |
| Organic Extraction | 6 | Dried sample on cotton swabs (−47° C. storage after drying) |
| | 1 | Environmental (outside (FL) - heat, sunlight, humidity, rain (3 days) |
| Direct Lysis (RLT) | 3 | Dried sample on cotton swabs (−47° C. storage after drying) |
| Menstrual Blood | 10 | |
| Organic Extraction | 7 | Dried sample on cotton swabs (−47° C. storage after drying) |
| Direct Lysis (RLT) | 3 | Dried sample on cotton swabs (−47° C. storage after drying) |
| Skin | 14 | |
| Organic Extraction | 1 | Swab of surface skin (male hand); swab moistened with sterile water |
| | 1 | Swab of coffee cup surface; swab moistened with sterile water |
| | 1 | Swab of computer mouse; swab moistened with sterile water |
| Direct Lysis (RLT) | 1 | Swab of surface skin (male hand); swab moistened with sterile water |
| | 1 | Swab of coffee cup surface; swab moistened with sterile water |
| | 1 | Swab of computer mouse; swab moistened with sterile water |
| Direct Lysis (RNAGEM) | 1 | 25 bio-particles (clumps); shirt collar (male) |
| | 1 | 50 bio-particles (clumps); shirt collar (male) |
| Direct Lysis | 1 | 100 bio-particles (55 clumps/45 singles); shirt collar (male) |
| (forensicGEM) | | |
| None | 5 | Skin total RNA (commercial source) |
| Mixtures | 5 | |
| Organic Extraction | 2 | Vaginal/semen (½ swab of each donor extracted in same tube) |
| | 2 | Blood/saliva ( 1/2 stain/swab of each donor extracted in same tube) |
| | 1 | Semen/saliva/vaginal (½ swab of each donor extracted in same |
| | | tube) |
| Controls | 3 | |
| Organic Extraction | 2 | Clean sterile swab (negative control) |
| None | 1 | Brain total RNA (commercial source) |

Stain = 50 μL stain;
Swab - saturated body fluid swab (sterile cotton)
Environmental samples (blood, semen, saliva) - on cotton cloth
Total RNA - commercial sources (see methods)

TABLE 3
Sample Descriptions and Assay Input (Full Sample Set)

| | | | Input | | Input | |
|---|---|---|---|---|---|---|
| Sample | Description | Extraction Type | μL | | (ng) | |
| 1 | 50 μl bloodstain on cotton cloth; donor 1 | Standard | 5 | μl | 50 | ng |
| 2 | 50 μl bloodstain on cotton cloth; donor 2 | Standard | 5 | μl | 50 | ng |
| 3 | 50 μl bloodstain on cotton cloth; donor 3 | Standard | 5 | μl | 50 | ng |
| 4 | 50 μl bloodstain on cotton cloth; donor 4 | Standard | 5 | μl | 50 | ng |
| 5 | Env. Bloodstain: outside, covered 3 day | Standard | 5 | μl | NA | |
| | (donor 5) | | | | | |
| 6 | 50 μl bloodstain on cotton cloth; donor 4 | Direct Lysis (RLT) | 5 | μl | NA | |
| 7 | Sat. semen swab (cotton, dried); donor 1 | Standard | 5 | μl | 50 | ng |
| 8 | Sat. semen swab (cotton, dried); donor 2 | Standard | 5 | μl | 50 | ng |
| 9 | Sat. semen swab (cotton, dried); donor 3 | Standard | 5 | μl | 50 | ng |
| 10 | Sat. semen swab (cotton, dried); donor 4 | Standard | 5 | μl | 50 | ng |
| 11 | Env: 50 μl semen on cotton cloth: | Standard | 5 | μl | NA | |
| | outside, covered 1 week (donor 5) | | | | | |
| 12 | ½ Sat. semen swab (cotton, dried); donor 1 | Direct Lysis (RLT) | 5 | μl | NA | |
| 13 | Buccal swab (cotton, dried); donor 1 | Standard | 5 | μl | 50 | ng |
| 14 | Buccal swab (cotton, dried); donor 2 | Standard | 5 | μl | 50 | ng |
| 15 | Buccal swab (cotton, dried); donor 3 | Standard | 5 | μl | 50 | ng |
| 16 | Buccal swab (cotton, dried); donor 4 | Standard | 5 | μl | 50 | ng |
| 17 | Env: 50 μl saliva on cotton cloth: | Standard | 5 | μl | 50 | ng |
| | outside, covered 1 month (donor 5) | | | | | |
| 18 | ½ buccal swab (cotton, dried); donor 6 | Direct Lysis (RLT) | 5 | μl | NA | |
| 19 | ½ Vaginal swab (cotton, dried); donor 1 | Standard | 5 | μl | 50 | ng |
| 20 | ½ Vaginal swab (cotton, dried); donor 2 | Standard | 5 | μl | 50 | ng |
| 21 | ½ Vaginal swab (cotton, dried); donor 3 | Standard | 5 | μl | 50 | ng |
| 22 | ½ Vaginal swab (cotton, dried); donor 4 | Standard | 5 | μl | 50 | ng |
| 23 | Env: ½ vaginal swab: | Standard | 5 | μl | 50 | ng |
| | outside, uncovered 3 days (donor 5) | | | | | |
| 24 | ½ Vaginal swab (cotton, dried); donor 2 | Direct Lysis (RLT) | 5 | μl | NA | |
| 25 | ½ menstrual blood swab (cotton; dried) | Standard | 5 | μl | 50 | ng |
| | donor 1, day 2 of menstruation | | | | | |
| 26 | ½ menstrual blood swab (cotton; dried) | Standard | 5 | μl | 50 | ng |
| | donor 2 | | | | | |
| 27 | ½ menstrual blood swab (cotton; dried) | Standard | 5 | μl | 50 | ng |
| | donor 3, day 1 of menstruation | | | | | |
| 28 | ½ menstrual blood swab (cotton; dried) | Standard | 5 | μl | 50 | ng |
| | donor 4, day 2 of menstruation | | | | | |
| 29 | ½ menstrual blood swab (cotton; dried) | Standard | 5 | μl | 50 | ng |
| | donor 5, Day 3 of menstruation | | | | | |
| 30 | ½ menstrual blood swab (cotton; dried) | Direct Lysis (RLT) | 5 | μl | NA | |
| | donor 1 | | | | | |
| 31 | Skin - total RNA (commercial source) | None | 5 | μl | 50 | ng |
| 32 | Skin - total RNA (commercial source) | None | 5 | μl | 50 | ng |
| 33 | Skin - total RNA (commercial source) | None | 5 | μl | 50 | ng |
| 34 | Skin - total RNA (commercial source) | None | 5 | μl | 50 | ng |
| 35 | Surface swab (whole) of computer mouse | Standard | 5 | μl | NA | |
| 36 | Surface swab (whole) of computer mouse | Direct Lysis (RLT) | 5 | μl | NA | |
| 37 | Semen (donor 2) - dilution series | Standard | 5 | μl | 25 | ng |
| 38 | Semen (donor 2) - dilution series | Standard | 5 | μl | 12.5 | ng |
| 39 | Semen (donor 2) - dilution series | Standard | 5 | μl | 6.25 | ng |
| 40 | Saliva (donor 1) - dilution series | Standard | 5 | μl | 25 | ng |
| 41 | Saliva (donor 1) - dilution series | Standard | 5 | μl | 12.5 | ng |
| 42 | Saliva (donor 1) - dilution series | Standard | 5 | μl | 6.25 | ng |
| 43 | Human Brain - total RNA (commercial | None | 5 | μl | 50 | ng |
| | source) | | | | | |
| 44 | Extraction blank (blank/clean swab) | Standard | 5 | μl | NA | |
| 45 | 100 bio-particles (55 clumps/45 singles); | Direct Lysis (FG) | 5 | μl | NA | |
| | male shirt collar | | | | | |
| 46 | Vaginal (donor 3) - semen (donor 1) mixture | Standard | 5 | μl | 50 | ng |
| | (½ swab of each) | | | | | |
| 47 | Blood (donor 1) - saliva (donor 2) mixture | Standard | 5 | μl | 50 | ng |
| | (½ swab of each) | | | | | |
| 48 | Semen (donor 1) - saliva (donor 2) - vaginal | Standard | 5 | μl | 50 | ng |
| | (donor 3) | | | | | |
| | (½ swab of each) | | | | | |
| 49 | ½ 50 μl bloodstain on cotton cloth; donor 6 | Standard | 10 | μl | 60 | ng |
| 50 | ½ 50 μl bloodstain on cotton cloth; donor 6 | Direct Lysis (RLT) | 5 | μl | NA | |
| 51 | Technical replicate of #50 | Direct Lysis (RLT) | 10 | μl | NA | |
| 52 | ½ 50 μl bloodstain on cotton cloth; donor 7 | Standard | 8 | μl | 104 | ng |
| 53 | ½ 50 μl bloodstain on cotton cloth; donor 7 | Direct Lysis (RLT) | 5 | μl | NA | |
| 54 | ½ 50 μl bloodstain on cotton cloth; donor 8 | Direct Lysis (RLT) | 5 | μl | NA | |
| 55 | ½ 50 μl bloodstain on cotton cloth; donor 8 | Direct Lysis (RLT) | 10 | μl | NA | |
| 56 | ½ Sat. semen swab (cotton, dried); donor 6 | Standard | 4 | μl | 108 | ng |
| 57 | ½ Sat. semen swab (cotton, dried); donor 6 | Direct Lysis (RLT) | 5 | μl | NA | |
| 58 | ½ Sat. semen swab (cotton, dried); donor 7 | Standard | 5.3 | μl | 101 | ng |
| 59 | ½ Sat. semen swab (cotton, dried); donor 7 | Direct Lysis (RLT) | 5 | μl | NA | |
| 60 | Technical replicate of #59 | Direct Lysis (RLT) | 10 | μl | NA | |
| 61 | ½ Sat. semen swab (cotton, dried); donor 8 | Direct Lysis (RLT) | 5 | μl | NA | |
| 62 | ½ Sat. semen swab (cotton, dried); donor 8 | Direct Lysis (RLT) | 10 | μl | NA | |
| 63 | ½ fresh buccal swab (cotton); donor 7 | Standard | 5 | μl | 610 | ng |
| 64 | ½ fresh buccal swab (cotton); donor 7 | Direct Lysis (RLT) | 5 | μl | NA | |
| 65 | ½ fresh buccal swab (cotton); donor 8 | Standard | 10 | μl | 470 | ng |
| 66 | ½ fresh buccal swab (cotton); donor 8 | Direct Lysis (RLT) | 5 | μl | NA | |
| 67 | Technical replicate of #66 | Direct Lysis (RLT) | 10 | μl | NA | |
| 68 | ½ fresh buccal swab (cotton); donor 9 | Direct Lysis (RLT) | 5 | μl | NA | |
| 69 | ½ fresh buccal swab (cotton); donor 9 | Direct Lysis (RLT) | 10 | μl | NA | |
| 70 | ½ fresh buccal swab (cotton); donor 9 | Direct Lysis (RLT) | 5 | μl | NA | |
| 71 | ½ fresh buccal swab (cotton); donor 9 | Direct Lysis (RLT) | 10 | μl | NA | |
| 72 | ½ vaginal swab (cotton; dried); donor 6 | Standard | 1 | μl | 332 | ng |
| 73 | ½ vaginal swab (cotton; dried); donor 6 | Direct Lysis (RLT) | 5 | μl | NA | |
| 74 | ½ vaginal swab (cotton; dried); donor 7 | Standard | 1 | μl | 255 | ng |
| 75 | ½ vaginal swab (cotton; dried); donor 7 | Direct Lysis (RLT) | 5 | μl | NA | |
| 76 | ½ menstrual blood swab (cotton; dried); | Standard | 1 | μl | 118 | ng |
| | donor 6, day 2 of menstruation | | | | | |
| 77 | ½ menstrual blood swab (cotton; dried); | Direct Lysis (RLT) | 5 | μl | NA | |
| | donor 6, day 2 of menstruation | | | | | |
| 78 | ½ menstrual blood swab (cotton; dried); | Standard | 3.6 | μl | 101 | ng |
| | donor 7 | | | | | |
| 79 | ½ menstrual blood swab (cotton; dried); | Direct Lysis (RLT) | 5 | μl | NA | |
| | donor 7 | | | | | |
| 80 | Technical replicate of #79 | Direct Lysis (RLT) | 10 | μl | NA | |
| 81 | Swab of human skin (male hand, left) | Standard | 10 | μl | 80 | ng |
| 82 | Swab of human skin (male hand, right) | Direct Lysis (RLT) | 5 | μl | NA | |
| 83 | Technical replicate of #88 | Direct Lysis (RLT) | 10 | μl | NA | |
| 84 | Swab of metal coffee cup surface (side 1) | Standard | 8.3 | μl | 100 | ng |
| 85 | Swab of metal coffee cup surface (side 2) | Direct Lysis (RLT) | 5 | μl | NA | |
| 86 | Technical replicate of #85 | Direct Lysis (RLT) | 10 | μl | NA | |
| 87 | 25 bio-particles (clumps); male shirt collar | Direct Lysis (RG) | 5 | μl | NA | |
| 88 | 50 bio-particles (clumps); male shirt collar | Direct Lysis (RG) | 5 | μl | NA | |
| 89 | Env: 50 μl semen on cotton cloth: | Standard | 1.3 | μl | 100 | ng |
| | outside, covered 1 week (donor 9) | | | | | |
| 90 | 50 μl bloodstain on cotton cloth; donor 9 | Standard | 7.1 | μl | 99 | ng |
| 91 | Vaginal (donor 4) - semen (donor 9) mixture | Standard | 1.0 | μl | 164 | ng |
| | (½ swab of each) | | | | | |
| 92 | Env: 50 μl saliva on cotton cloth: | Standard | 7.7 | μl | 100 | ng |
| | outside, covered 1 week (donor 10) | | | | | |
| 93 | ½ Sat. semen swab (cotton, dried); donor 10 | Standard | 4.3 | μl | 99 | ng |
| 94 | blood (donor 10) - saliva (donor 7) mixture | Standard | 2.0 | μl | 98 | ng |
| | (½ swab of each) | | | | | |
| 95 | Extraction blank (blank/clean swab) | Standard | 5.0 | μl | 0 | ng |
| 96 | dried buccal swab (cotton); donor 1 | Standard | 1.0 | μl | 133 | ng |
| 97 | Env: 50 μl blood on cotton cloth: | Standard | 2.0 | μl | 106 | ng |
| | outside, uncovered 1 month (donor 11) | | | | | |
| 98 | Skin - total RNA (commercial source) | Standard | 2.0 | μl | 100 | ng |

Env = environmental;
direct lysis (FG) = forensicGEM ™;
direct Lysis (RG) = RNAGEM ™

### Estimating Expected Body Fluid Profiles

In some embodiments, datasets may include samples of highly varying RNA concentration, and may also include genes in the lower-concentration samples frequently dropped into the background noise of the assay. To ensure accurate estimates of each body fluid's average gene expression profile, samples with high expression levels of housekeeping genes may be retained for further processing.

Per the model described in the disclosure for model for gene expression in mixtures of body fluids, in some embodiments, the relative expression levels of the genes within each body fluid may be obtained; in other words, the proportion of total signature gene expression expected from each gene in a given body fluid. This is in contrast to most gene expression-based classifiers, which are more interested in each gene's absolute expression level, which can be difficult if not impossible to obtain. Therefore, each sample may be globally normalized, rescaling them so the sum of all expression values may be one value (e.g., 1) and so that each gene's expression value may be its proportion of the total signature gene expression. Then, each gene's expected proportion of expression in each fluid with its mean normalized expression value within each fluid may be estimated.

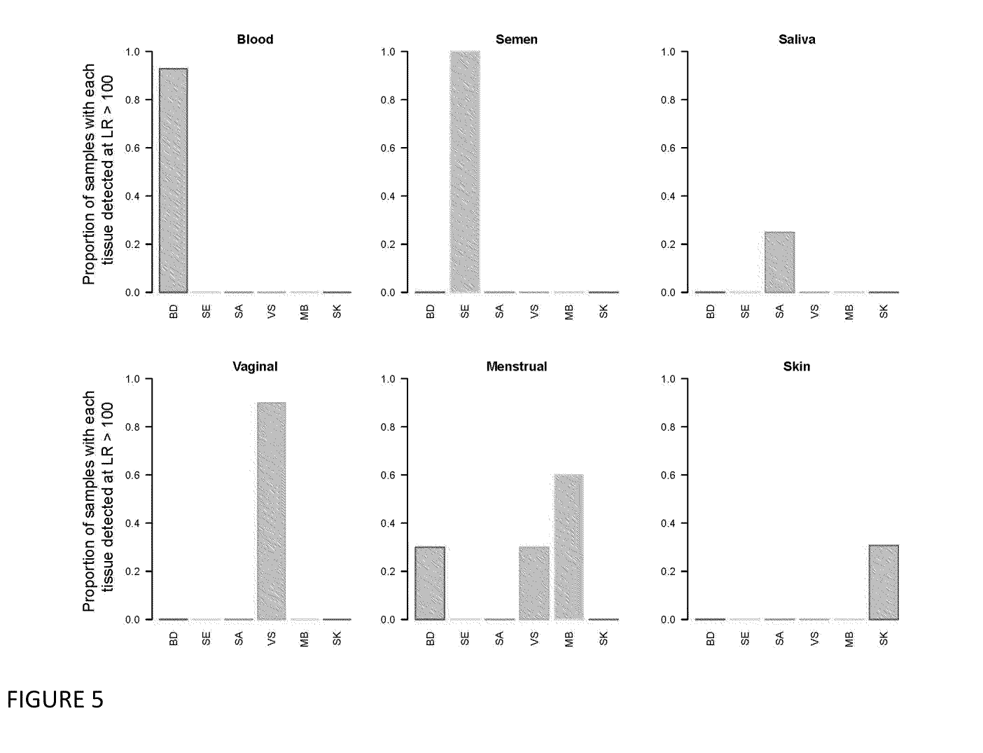

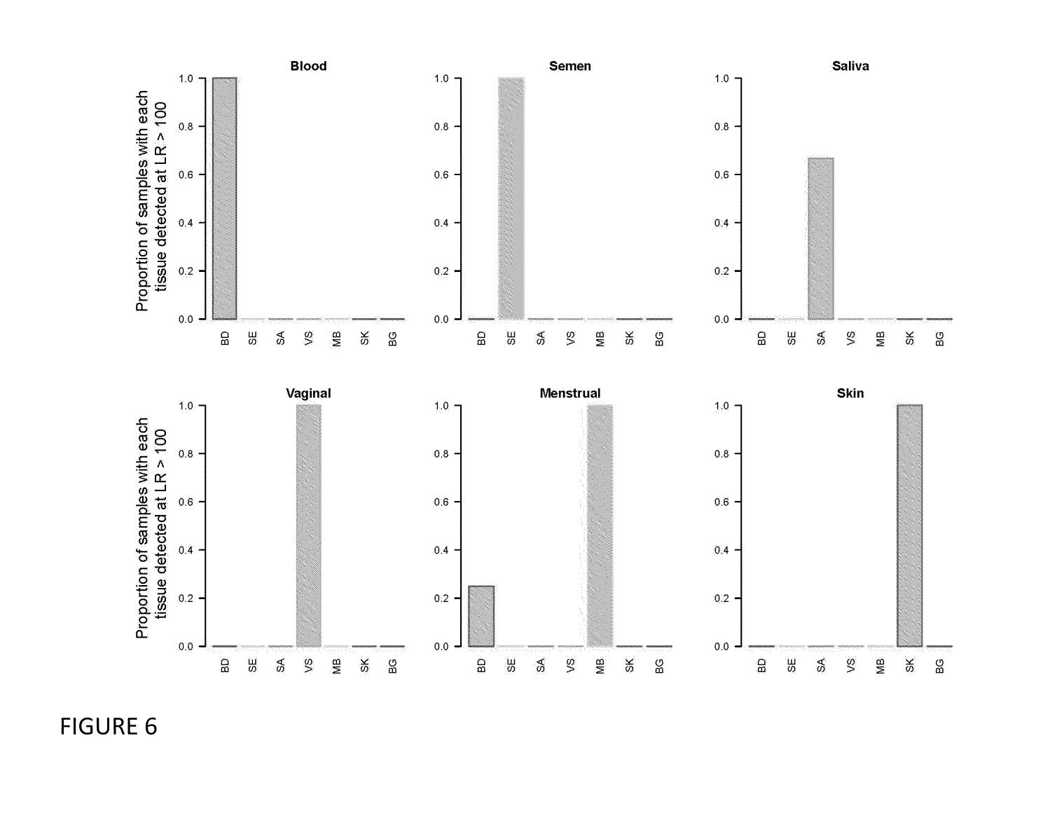

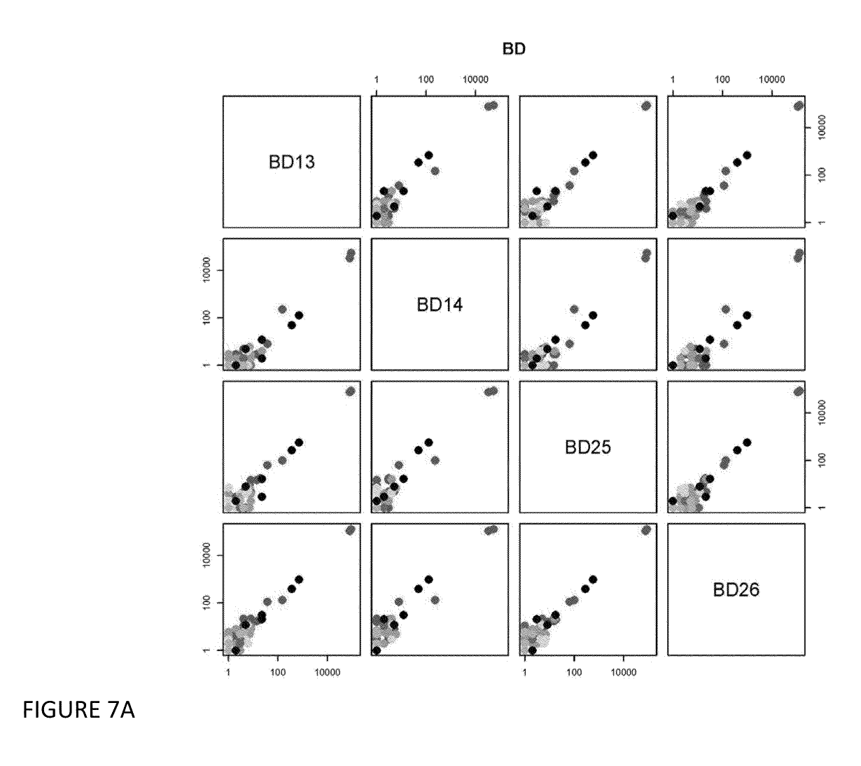

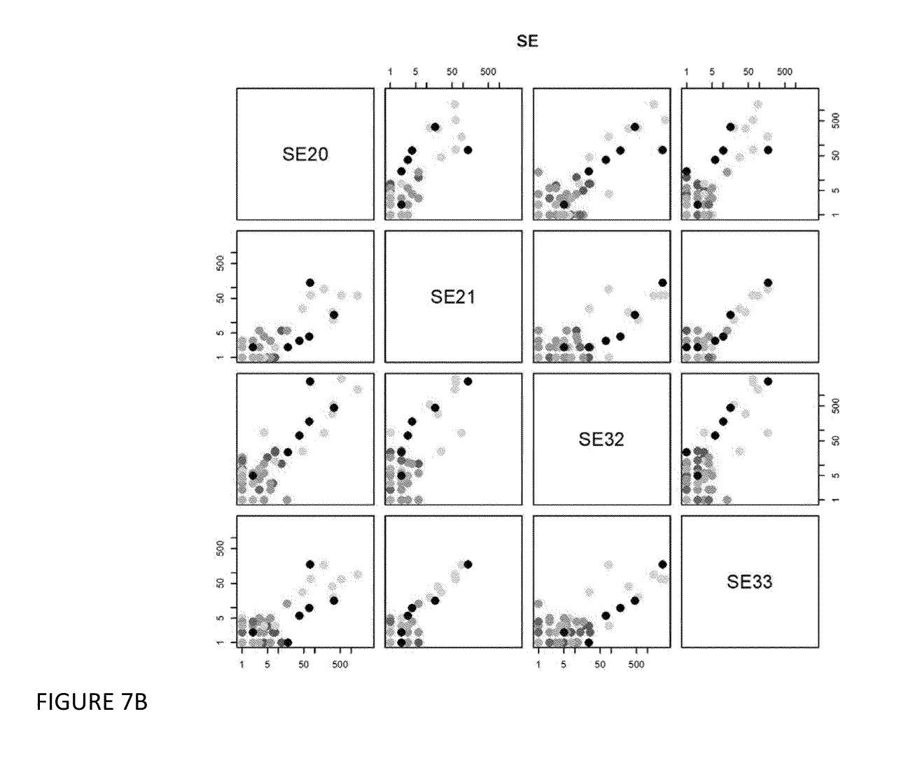

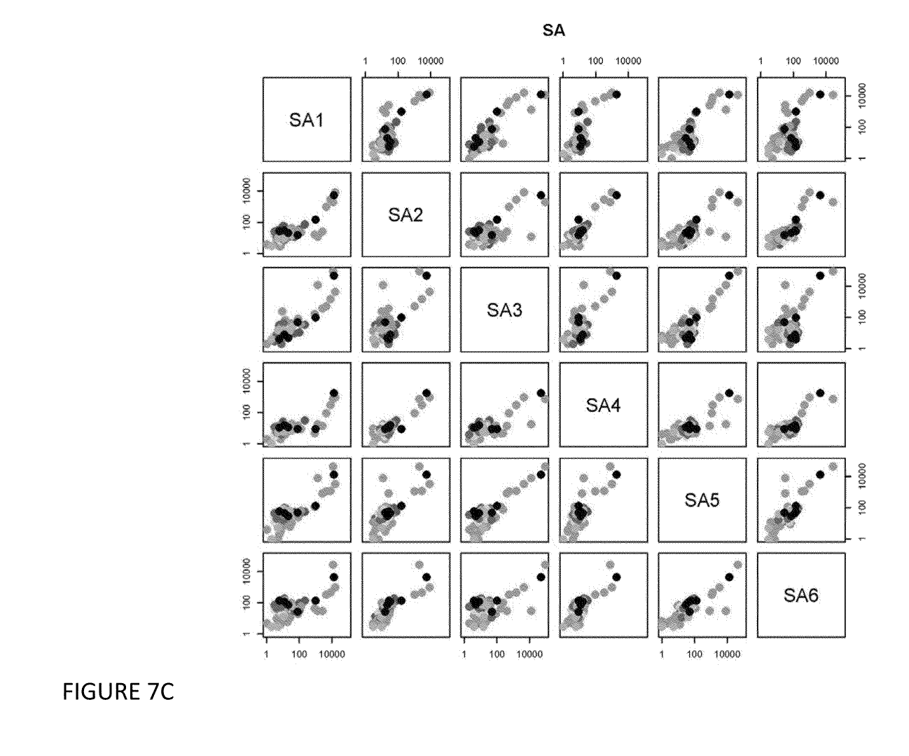

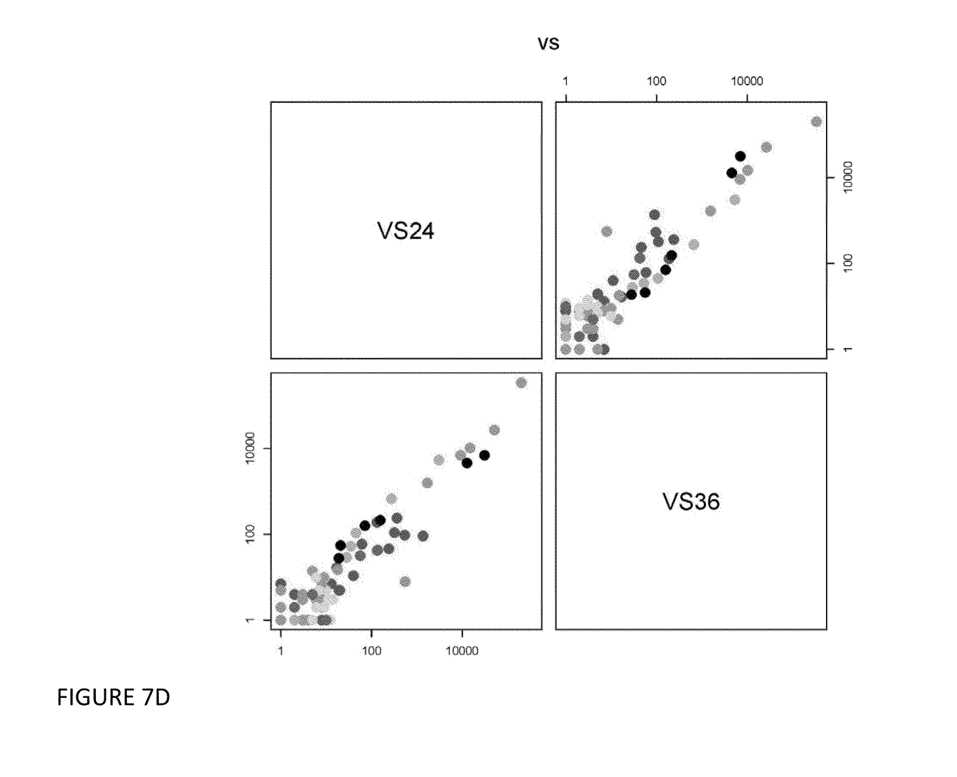

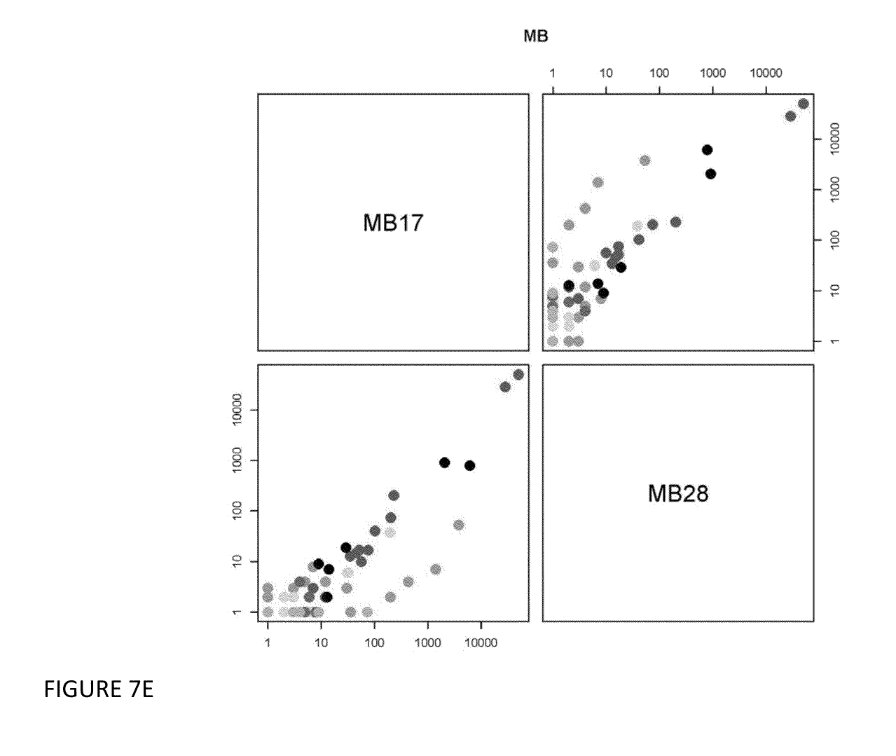

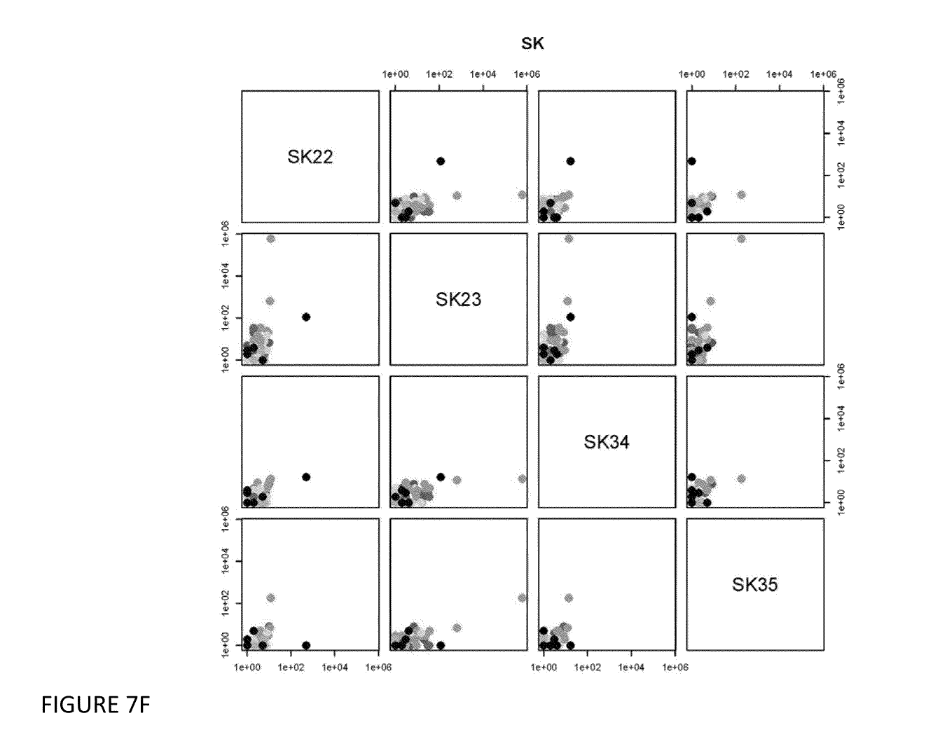

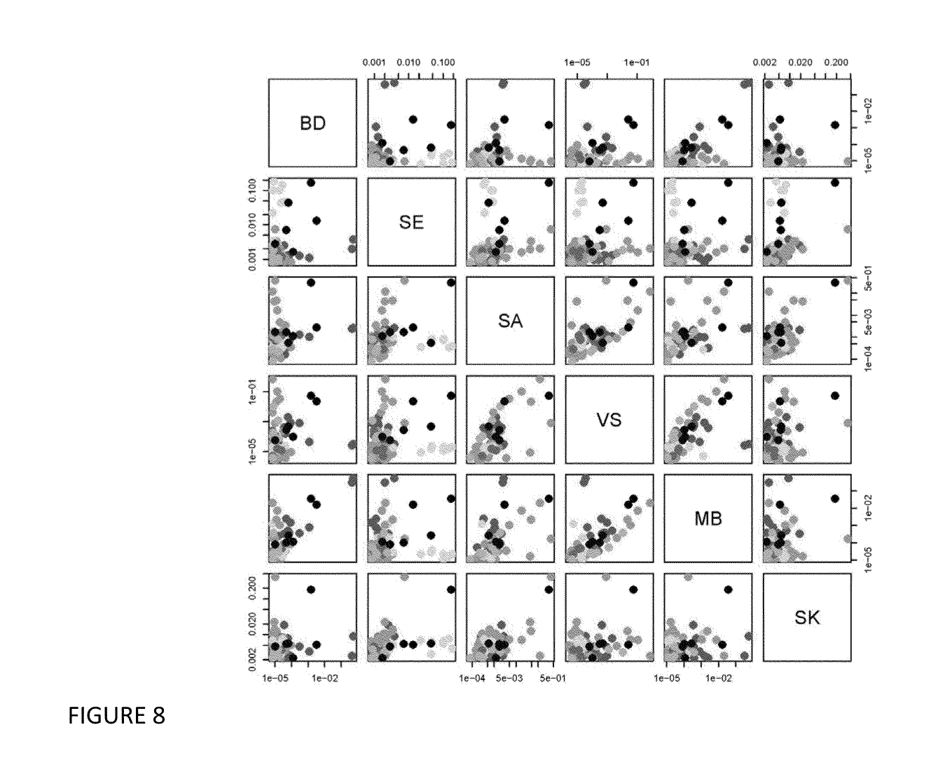

The five exemplary body fluids and skin, in some embodiments, may demonstrate highly distinct gene expression profiles, and although the signature genes may vary between samples of the same fluid, their differences between fluids may be much greater. In at least some fluids, the average expression profile may exhibit elevated expression of the fluid's putative characteristic genes, although this trend may under some circumstances be distinctly weaker in saliva samples. (See, FIGS. 5 to 8)

In some embodiments, HBB expression may dominate the blood profiles, far exceeding other blood markers such as ALAS2, ALOX5AP, AM1CA1, ANK1, AQP9, ARHGAP26, C1QR1, C5R1, CASP2, CD3G, GYPA, HBA, HMBS (PBGD), MNDA, NCFS2, and SPTB, although ALAS2 levels in blood may greatly exceed those of other genes. The putative blood marker ANK1 may not be enriched in blood samples, and may appear most prominently in saliva samples. In some circumstances, expression in semen samples may primarily come from the semen-specific genes IZUMO1, MSP, PSA (KLK3), PRM1, PRM2, SEMG1, SEMG2, and TGM4, although other genes, particularly HBB, may also be detectable. Saliva samples may have the most diffuse profile, with saliva-specific genes such as HTN3, MUC7, S. mutans 16S, S. mutans proC, S. mutans relA, S. mutans rplA, S. mutans rpoB, S. mutans rpoS, S. salivarius 16S, S. salivarius proC, S. salivarius relA, S. salivarius rplA, S. salivarius rpoB, S. salivarius rpoS, SMR3B, and STATH contributing, in some circumstances, only 28% of total measured expression. Vaginal secretion samples may have highly elevated levels of vaginal markers such as DKK4, CYP2B7P1 and to a lesser extent FUT6. Menstrual blood samples may show elevated expression of their characteristic genes, including LEFTY2, MMPI, MMP10, and MMP11. Menstrual blood samples may also contain blood (HBB, ALAS2) and vaginal secretion (CYP2B7P1) biomarkers. Skin samples may show elevated expression of skin genes such as LCE1C, IL1F7 and CCL27, although these genes may also be slightly elevated in vaginal secretions and menstrual blood. In some circumstances, HBB may be the most prevalent gene in the commercial skin preparation, in part due to the potential presence of contaminating endothelial tissue in such preparations.

At least some of the genes may be present at a non-negligible proportion of total expression in the saliva samples. If a gene highly expressed in saliva were measured, the relative expression of the other fluids' characteristic genes in saliva may shrink dramatically.

### Using Gene Expression to Predict the Body Fluid Composition of Samples

As described above, an exemplary algorithm according to some embodiments for a body fluid detection method is provided. Below is a summary of the performance predicting the body fluid composition of samples. A likelihood ratio cutoff of 100 may be used to declare whether a body fluid was detected in a given sample. In some embodiments, fluids may be called detected if their likelihood ratio exceeds 100. The algorithm may be successful in identifying the correct body fluid. If the characteristic genes for a given substance is not generally informative (e.g., there are few unique and easily detected genes in the substance), refinement of the algorithm may be performed in order to determine ways of improving the calculation in the absence of informative genetic data. In some embodiments, the sensitivity of the algorithm may be improved if samples are not degraded and/or miniscule.

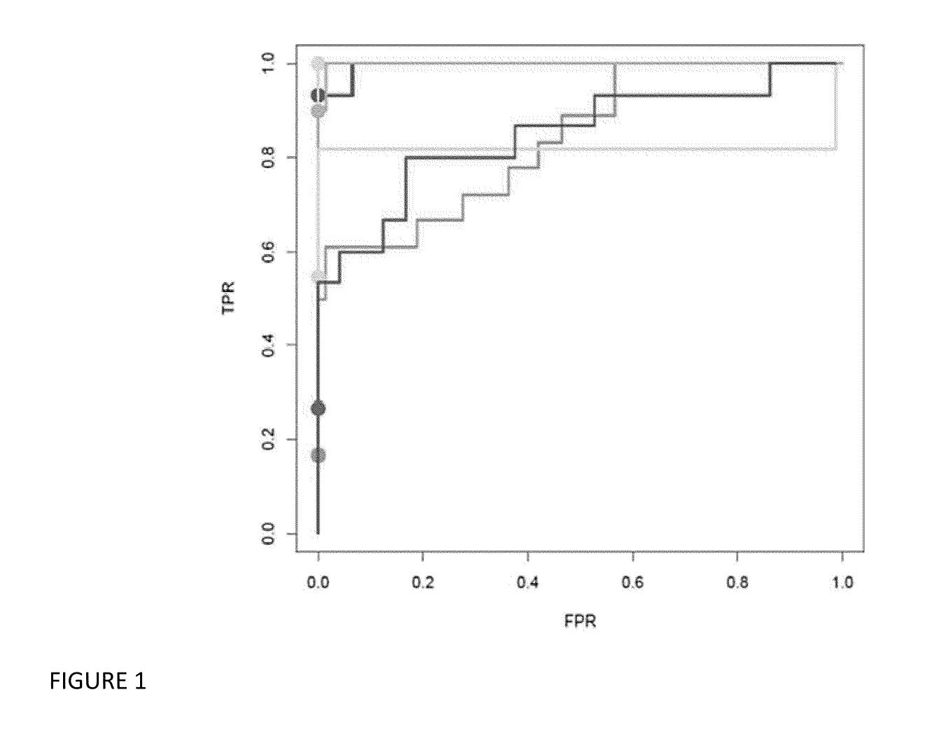

In some embodiments, the algorithm may achieve better performance via varying the LR>100 cutoff. FIG. 1 shows exemplary ROC curves for the True Positive Rate (TPR) and False Positive Rate (FPR) for detection of exemplary forensic fluid types, according to some embodiments. As the LR threshold relaxes the algorithm and may return more of both false positives and false negatives. For some substances, such as menstrual blood, saliva and skin, the ROC curves reveal that a modest relaxation of the LR threshold may result in large increases in TPR without any increase in FPR. The points indicate, in some embodiments, the performance achieved using a LR cutoff of 100. Thus, altering the LR cutoff may improve detection of substances in a sample without resulting in an increase in other errors.

### BODY Fluid Mixtures

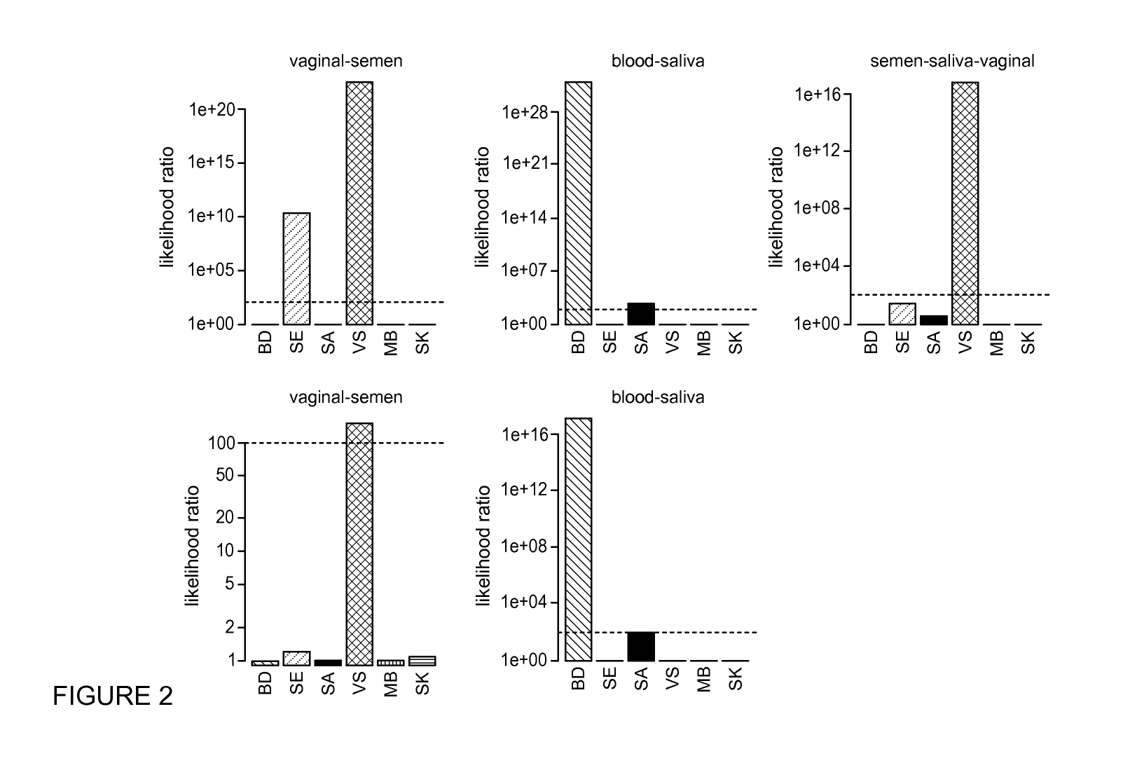

As a preliminary indication of the ability of the method to discern admixtures of body fluids, five mixtures may be prepared by combining ½ of a 50 μl stain or single cotton swab from each body fluid. An exemplary mixture could comprise four binary (2× vaginal secretions/semen, 2× blood/saliva) and one ternary mixture (semen/saliva/vaginal secretions). The blood/saliva and vaginal secretions/semen may be biological, as opposed to technical, replicates. Using an LR of 100 as a decision threshold, several of the mixtures may be called perfectly, namely one of the vaginal secretions/semen and one of the blood/saliva samples (e.g., FIG. 2). In some embodiments, for each of five exemplary mixture samples, a bar plot shows the likelihood ratios for the presence of each fluid type. The dotted line indicates a LR of 100. Significantly, no false positives may be observed when utilizing the statistical methods disclosed herein on the exemplary samples.

### Development of a Routine-Use 5 Minute RNA Direct Lysis Method

To facilitate routine analysis, a 5 minute room temperature cellular lysis protocol may be employed as an alternative to standard RNA isolation for forensic sample processing using the procedures outlined above. The method may be based upon the RLT buffer from QIAGEN which contains a high concentration of guanidine thiocyanate as well as a proprietary mix of detergents. β-mercaptoethanol (1% v/v) may also be added before use to inactivate RNAses in the lysate. Unlike most direct lysis reagents, the RLT buffer permits many biochemical reactions, such as hybridization, to take place. The released nucleic acids may be principally in the form of single stranded RNA and double stranded DNA, the latter of which therefore cannot hybridize to the single stranded probes. This fact, together with the lack of DNA titration of the assay probes to homologous DNA sequences and other reagents, thus may increase RNA assay sensitivity and specificity.

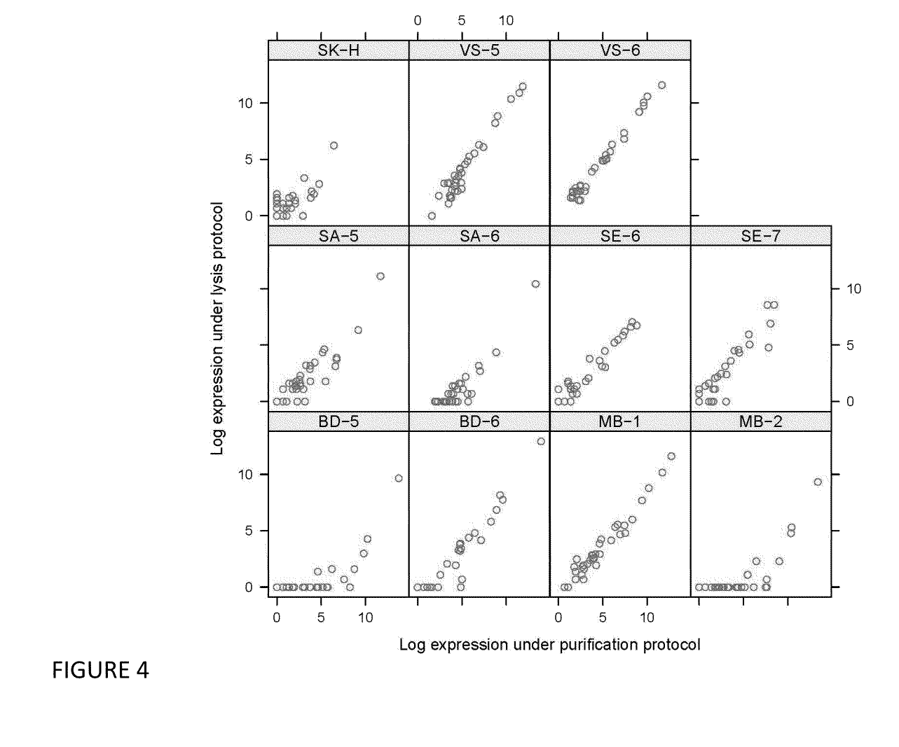

The reproducibility of the assay between standard RNA isolation/purification and direct lysis protocols from the same source material can be compared. In general, excellent concordance between the two protocols for all genes with a moderate to high degree of expression may be observed. The correlation between the protocols may break down for very lowly-expressed genes, reflecting the greater noise in the assay when measuring vanishing target. The most dramatic differences between replicates may be attributable to expected variance in RNA input amounts between lysate and purified RNA since lysate concentration is not reliably measureable by current methods. The concordance observed between lysis and purified protocols suggest that the simpler, 5 minute lysis protocol would be an efficient option for routine forensic casework workflow. (See, FIG. 4).

Additionally, the samples excluded from training may suffer no overfitting. In some embodiments, the algorithm may utilize an LR >100 as the decision threshold for all body fluid types; in other embodiments, an alternative approach using body fluid specific thresholds may be utilized.

In some implementations, further optimization of the Codeset may be possible. For example, attenuating the HBB signal with the addition of precisely defined quantities of specifically designed unlabeled oligonucleotides complementary to the HBB RNA prior to hybridization with the full Codeset may aid in avoiding false positives arising from low level contamination with vascular tissue products. These competitively inhibit the hybridization reaction with the labeled probes. In contrast to the need to attenuate one of the blood biomarkers, the signal for the saliva biomarkers may be enhanced. Signal intensification may be accomplished by designing multiple probes that bind along a single HTN3 mRNA. In addition, the current probes may be designed to hybridize to both HTN3 and HTN1, the latter of which is also saliva specific. Alternative novel biomarkers identified by RNA-Seq studies may also be employed if the HTN3 intensification strategies fall short of expectations. In some embodiments, the ANKI probes may be re-synthesized or re-designed, and a similar approach may be taken with any non-optimally performing biomarkers. In some embodiments, additional body fluid specific biomarkers (e.g., commensal bacteria from the vagina, such as Lactobacillus sp.) may also be incorporated in order to improve assay performance.

In some embodiments, the algorithm may discern admixtures of body fluids, e.g., as shown in FIG. 2. Some of the mixtures may be called perfectly using the assay algorithm with no false positive results, and some of the component fluids may identified in any ‘false negative’ mixtures. In the false negative mixtures, the missed fluid, saliva may be detected at a level far above the other samples. Housekeeping genes may be added to gene expression assays to indicate that RNA of sufficient quality and quantity for analysis is present, and for normalization purposes (Hanson et al, Forensic Sci Rev., 2010; Haas et al, Forensic Sci Int Genet., 2014; Juusola and Ballantyne, J Forensic Sci., 2007). Due to non-uniform expression of housekeeping genes their value as normalizers is questionable (Moreno et al, J. Forensic Sci., 2012; Vandesompele et al, Genome Biol., 2002). In some embodiments, the disclosed algorithm does not require normalization with housekeeping genes and will not be required for this purpose. However their presence may indicate the recovery of suitable RNA for analysis and therefore may still have a certain utility in the assay.

Any and all references to publications or other documents, including but not limited to, patents, patent applications, articles, webpages, books, etc., presented in the present application, are herein incorporated by reference in their entirety, except insofar as the subject matter may conflict with that of the embodiments of the present disclosure (in which case what is present herein shall prevail). The referenced items are provided solely for their disclosure prior to the filing date of the present application. Nothing herein is to be construed as an admission that any invention disclosed herein is not entitled to antedate such material by virtue of prior invention.

Although example embodiments of the apparatuses, methods and systems have been described herein, other modifications to such embodiments are possible. These embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. In addition, any logic flow depicted in the above disclosure and/or accompanying figures may not require the particular order shown, or sequential order, to achieve desirable results. Moreover, embodiments of the subject disclosure may include methods, systems and devices which may further include any and all elements from any other disclosed methods, systems, and devices, including any and all elements corresponding to gene expression and the utilization of samples. In other words, elements from one and/or another disclosed embodiment may be interchangeable with elements from other disclosed embodiments. In addition, one or more features/elements of disclosed embodiments may be removed and still result in patentable subject matter (and thus, resulting in yet more embodiments of the subject disclosure). Still further, some embodiments of the present disclosure may be distinguishable from the prior art for expressly not requiring one and/or another feature disclosed in the prior art (e.g., some embodiments may include negative limitations). Some of the embodiments disclosed herein are within the scope of at least some of the following exemplary claims of the numerous claims which are supported by the present disclosure which may be presented.

### REFERENCES

[1] J. Butler, Advanced Topics in Forensic DNA Typing: Methodology, Elsevier/Academic Press, San Diego, Calif., 2012.
[2] R. Cook, I. Evett, G. Jackson, P. Jone, A. Lambert, A hierarchy of propositions: deciding which level to address in casework, Science & Justice. 38 (1998) 231-239.
[3] J. Juusola, J. Ballantyne, Messenger RNA profiling: a prototype method to supplant conventional methods for body fluid identification, Forensic Sci Int. 135 (2003) 85-96.
[4] B. Alberts, D. Bray, J. Lewis, M. Raff, K. Roberts, J. D. Watson, Molecular Biology of the Cell, 2nd, Garland Publishing, New York, N.Y., 1994.
[5] C. Haas, E. Hanson, J. Ballantyne, Capillary electrophoresis of a multiplex reverse transcription-polymerase chain reaction to target messenger RNA markers for body fluid identification, Methods Mol. Biol. 830 (2012) 169-183.
[6] E. Hanson, J. Ballantyne, RNA Profiling for the Identification of the Tissue Origin of Dried Stains in Forenic Biology, Forensic Sci Rev. 22 (2010) 145-157.
[7] C. Haas, B. Klesser, C. Maake, W. Bar, A. Kratzer, mRNA profiling for body fluid identification by reverse transcription endpoint PCR and realtime PCR, Forensic Sci Int Genet. 3 (2009) 80-88.
[8] M. Setzer, J. Juusola, J. Ballantyne, Recovery and stability of RNA in vaginal swabs and blood, semen, and saliva stains, J Forensic Sci. 53 (2008) 296-305.
[9] D. Zubakov, E. Hanekamp, M. Kokshoorn, I. W. van, M. Kayser, Stable RNA markers for identification of blood and saliva stains revealed from whole genome expression analysis of time-wise degraded samples, Int. J. Legal Med. 122 (2008) 135-142.
[10] D. Zubakov, M. Kokshoorn, A. Kloosterman, M. Kayser, New markers for old stains: stable mRNA markers for blood and saliva identification from up to 16-year-old stains, Int J. Legal Med. 123 (2009) 71-74.
[11] C. Haas, E. Hanson, W. Bar, R. Banemann, A. M. Bento, A. Berti, E. Borges, C. Bouakaze, A. Carracedo, M. Carvalho, A. Choma, M. Dotsch, M. Duriancikova, P. Hoff-Olsen, C. Hohoff, P. Johansen, P. A. Lindenbergh, B. Loddenkotter, B. Ludes, O. Maronas, N. Morling, H. Niederstatter, W. Parson, G. Patel, C. Popielarz, E. Salata, P. M. Schneider, T. Sijen, B. Sviezena, L. Zatkalikova, J. Ballantyne, mRNA profiling for the identification of blood—results of a collaborative EDNAP exercise, Forensic Sci Int Genet. 5 (2011) 21-26.
[12] C. Haas, E. Hanson, N. Morling, J. Ballantyne, Collaborative EDNAP exercises on messenger RNA/DNA co-analyis for body fluid identification (blood, saliva, semen) and STR profiling, Forensic Sci. Int. Genet. Supp. Ser. 3 (2011) e5-e6.
[13] C. Haas, E. Hanson, M. J. Anjos, W. Bar, R. Banemann, A. Berti, E. Borges, C. Bouakaze, A. Carracedo, M. Carvalho, V. Castella, A. Choma, C. G. De, M. Dotsch, P. Hoff-Olsen, P. Johansen, F. Kohlmeier, P. A. Lindenbergh, B. Ludes, O. Maronas, D. Moore, M. L. Morerod, N. Morling, H. Niederstatter, F. Noel, W. Parson, G. Patel, C. Popielarz, E. Salata, P. M. Schneider, T. Sijen, B. Sviezena, M. Turanska, L. Zatkalikova, J. Ballantyne, RNA/DNA co-analysis from blood stains—results of a second collaborative EDNAP exercise, Forensic Sci Int Genet. 6 (2012) 70-80.
[14] C. Haas, E. Hanson, M. J. Anjos, R. Banemann, A. Berti, E. Borges, A. Carracedo, M. Carvalho, C. Courts, C. G. De, M. Dotsch, S. Flynn, I. Gomes, C. Hollard, B. Hjort, P. Hoff-Olsen, K. Hribikova, A. Lindenbergh, B. Ludes, O. Maronas, N. McCallum, D. Moore, N. Morling, H. Niederstatter, F. Noel, W. Parson, C. Popielarz, C. Rapone, A. D. Roeder, Y. Ruiz, E. Sauer, P. M. Schneider, T. Sijen, Court D S, B. Sviezena, M. Turanska, A. Vidaki, L. Zatkalikova, J. Ballantyne, RNA/DNA co-analysis from human saliva and semen stains—results of a third collaborative EDNAP exercise, Forensic Sci Int Genet. 7 (2013) 230-239.
[15] C. Haas, E. Hanson, M. J. Anjos, K. N. Ballantyne, R. Banemann, B. Bhoelai, E. Borges, M. Carvalho, C. Courts, C. G. De, K. Drobnic, M. Dotsch, R. Fleming, C. Franchi, I. Gomes, G. Hadzic, S. A. Harbison, J. Harteveld, B. Hjort, C. Hollard, P. Hoff-Olsen, C. Huls, C. Keyser, O. Maronas, N. McCallum, D. Moore, N. Morling, H. Niederstatter, F. Noel, W. Parson, C. Phillips, C. Popielarz, A. D. Roeder, L. Salvaderi, E. Sauer, P. M. Schneider, G. Shanthan, Court D S, M. Turanska, R. A. van Oorschot, M. Vennemann, A. Vidaki, L. Zatkalikova, J. Ballantyne, RNA/DNA co-analysis from human menstrual blood and vaginal secretion stains: results of a fourth and fifth collaborative EDNAP exercise, Forensic Sci Int Genet. 8 (2014) 203-212.
[16] C. Courts, B. Madea, Specific micro-RNA signatures for the detection of saliva and blood in forensic body-fluid identification, J. Forensic Sci. 56 (2011) 1464-1470.
[17] E. Hanson, K. Rekab, J. Ballantyne, Binary logistic regression models enable miRNA profiling to provide accurate identification of forensically relevant body fluids and tissues, For Sci Int Genet Supp Ser. 4 (2013) e127-e128.
[18] E. Hanson, H. Lubenow, J. Ballantyne, Identification of forensically relevant body fluids using a panel of differentially expressed microRNAs, Forensic Sci. Int. Genet. Supplement Series 2 (2009) 503-504.
[19] E. K. Hanson, H. Lubenow, J. Ballantyne, Identification of Forensically Relevant Body Fluids Using a Panel of Differentially Expressed microRNAs, Anal. BioChem. 387 (2009) 303-314.
[20] Z. Wang, H. Luo, X. Pan, M. Liao, Y. Hou, A model for data analysis of microRNA expression in forensic body fluid identification, Forensic Sci. Int. Genet. 6 (2012) 419-423.
[21] Z. Wang, J. Zhang, H. Luo, Y. Ye, J. Yan, Y. Hou, Screening and confirmation of microRNA markers for forensic body fluid identification, Forensic Sci. Int. Genet. 7 (2013) 116-123.
[22] D. Zubakov, A. W. Boersma, Y. Choi, P. F. van Kuijk, E. A. Wiemer, M. Kayser, MicroRNA markers for forensic body fluid identification obtained from microarray screening and quantitative RT-PCR confirmation, Int J. Legal Med. 124 (2010) 217-226.
[23] J. H. An, A. Choi, K. J. Shin, W. I. Yang, H. Y. Lee, DNA methylation-specific multiplex assays for body fluid identification, Int. J. Legal Med. 127 (2013) 35-43.
[24] A. Choi, K. J. Shin, W. I. Yang, H. Y. Lee, Body fluid identification by integrated analysis of DNA methylation and body fluid-specific microbial DNA, Int J. Legal Med. 128 (2014) 33-41.
[25] D. Frumkin, A. Wasserstrom, B. Budowle, A. Davidson, DNA methylation-based forensic tissue identification, Forensic Sci. Int. Genet. 5 (2011) 517-524.
[26] B. L. LaRue, J. L. King, B. Budowle, A validation study of the Nucleix DSI-Semen kit—a methylation-based assay for semen identification, Int. J. Legal Med. 127 (2013) 299-308.
[27] H. Y. Lee, M. J. Park, A. Choi, J. H. An, W. I. Yang, K. J. Shin, Potential forensic application of DNA methylation profiling to body fluid identification, Int. J. Legal Med. 126 (2012) 55-62.
[28] T. Madi, K. Balamurugan, R. Bombardi, G. Duncan, B. McCord, The determination of tissue-specific DNA methylation patterns in forensic biofluids using bisulfite modification and pyrosequencing, Electrophoresis. 33 (2012) 1736-1745.
[29] A. Wasserstrom, D. Frumkin, A. Davidson, M. Shpitzen, Y. Herman, R. Gafny, Demonstration of DSI-semen—A novel DNA methylation-based forensic semen identification assay, Forensic Sci. Int. Genet. 7 (2013) 136-142.
[30] J. L. Simons, S. K. Vintiner, Efficacy of several candidate protein biomarkers in the differentiation of vaginal from buccal epithelial cells, J. Forensic Sci. 57 (2012) 1585-1590.
[31] S. K. Van, C. M. De, M. Dhaenens, H. D. Van, D. Deforce, Mass spectrometry-based proteomics as a tool to identify biological matrices in forensic science, Int. J. Legal Med. 127 (2013) 287-298.
[32] H. Yang, B. Zhou, M. Prinz, D. Siegel, Proteomic analysis of menstrual blood, Mol. Cell Proteomics. 11 (2012) 1024-1035.
[33] E. Hanson, C. Haas, R. Jucker, J. Ballantyne, Specific and sensitive mRNA biomarkers for the identification of skin in ‘touch DNA’ evidence, Forensic Sci Int Genet. 6 (2012) 548-558.
[34] J. Juusola, J. Ballantyne, Multiplex mRNA profiling for the identification of body fluids, Forensic Sci Int. 152 (2005) 1-12.
[35] M. L. Richard, K. A. Harper, R. L. Craig, A. J. Onorato, J. M. Robertson, J. Donfack, Evaluation of mRNA marker specificity for the identification of five human body fluids by capillary electrophoresis, Forensic Sci Int Genet. 6 (2012) 452-460.
[36] A. D. Roeder, C. Haas, mRNA profiling using a minimum of five mRNA markers per body fluid and a novel scoring method for body fluid identification, Int J Legal Med. 127 (2013) 707-721.
[37] M. Bauer, D. Patzelt, Identification of menstrual blood by real time RT-PCR: technical improvements and the practical value of negative test results, Forensic Sci Int. 174 (2008) 55-59.
[38] J. Juusola, J. Ballantyne, mRNA profiling for body fluid identification by multiplex quantitative RT-PCR, J Forensic Sci. 52 (2007) 1252-1262.
[39] C. Nussbaumer, E. Gharehbaghi-Schnell, I. Korschineck, Messenger RNA profiling: a novel method for body fluid identification by real-time PCR, Forensic Sci Int. 157 (2006) 181-186.
[40] E. K. Hanson, J. Ballantyne, Rapid and inexpensive body fluid identification by RNA profiling-based multiplex High Resolution Melt (HRM) analysis, F1000Res. 2 (2013) 281.
[41] S. Audic, J. M. Claverie, The significance of digital gene expression profiles, Genome Res. 7 (1997) 986-995.
[42] Z. Wang, M. Gerstein, M. Snyder, RNA-Seq: a revolutionary tool for transcriptomics, Nat. ReV. Genet. 10 (2009) 57-63.
[43] G. K. Geiss, R. E. Bumgarner, B. Birditt, T. Dahl, N. Dowidar, D. L. Dunaway, H. P. Fell, S. Ferree, R. D. George, T. Grogan, J. J. James, M. Maysuria, J. D. Mitton, P. Oliveri, J. L. Osborn, T. Peng, A. L. Ratcliffe, P. J. Webster, E. H. Davidson, L. Hood, K. Dimitrov, Direct multiplexed measurement of gene expression with color-coded probe pairs, Nat. Biotechnol. 26 (2008) 317-325.
[44] E. K. Hanson, J. Ballantyne, “Getting blood from a stone”: ultrasensitive forensic DNA profiling of microscopic bio-particles recovered from “touch DNA” evidence, Methods Mol. Biol. 1039 (2013) 3-17.
[45] E. K. Hanson, J. Ballantyne, Highly specific mRNA biomarkers for the identification of vaginal secretions in sexual assault investigations, Sci Justice. 53 (2013) 14-22.
[46] E. Hanson, C. Haas, R. Jucker, J. Ballantyne, Identification of skin in touch/contact forensic samples by messenger RNA profiling, Forensic Sci Int Genet. Suppl Series. 3 (2011) e305-e306.
[47] R. H. Byrd, P. Lu, J. N Cedal, C. Zhu, A limited memory algorithm for bound constrained optimization, SIAM J. Scientific Computing. 1995) 1190-1208.
[48] L. I. Moreno, C. M. Tate, E. L. Knott, J. E. McDaniel, S. S. Rogers, B. W. Koons, M. F. Kavlick, R. L. Craig, J. M. Robertson, Determination of an effective housekeeping gene for the quantification of mRNA for forensic applications, J. Forensic Sci. 57 (2012) 1051-1058.
[49] J. Vandesompele, P. K. De, F. Pattyn, B. Poppe, R. N. Van, P. A. De, F. Speleman, Accurate normalization of real-time quantitative RT-PCR data by geometric averaging of multiple internal control genes, Genome Biol. 3 (2002).

What is claimed is:

1. A method for forensic biological sample identification, comprising:
obtaining at least one biological sample for analysis;
extracting a total RNA from the biological sample;
hybridizing the total RNA with at least one probe, in at least one assay; and
analyzing the at least one assay using a multiplex codeset, wherein analyzing comprises:
determining a set of genes to quantify in the sample;
modelling gene expression of each gene in the set of genes via generating a gene expression log function for each gene in the set of genes; and
generating a maximum likelihood estimation of an amount of a biological substance in the biological sample based on the modelled gene expression of each gene in the set of genes.

2. The method of claim 1, wherein the biological sample is a tissue sample.

3. The method of claim 1, wherein the substance is at least one of skin, venous blood, vaginal secretion, saliva, menstrual blood, semen, and bio-particles.

4. The method of claim 1, wherein the biological sample may comprise at least two biological substances.

5. The method of claim 1, wherein the total RNA is extracted from the biological sample using at least one of direct lysis with purification and direct lysis without purification.

6. The method of claim 5, wherein extracting the total RNA from the biological sample includes lysing the biological sample at 75° C. for about five minutes.

7. The method of claim 1, wherein the at least one probe includes at least of a reporter probe and a capture probe.

8. The method of claim 1, wherein the multiplex codeset specifies probe pairs for targeting the set of genes.

9. The method of claim 1, wherein the multiplex codeset includes at least one of:
venous blood genes ALAS2, ALOX5AP, AM1CA1, ANK1, AQP9, ARHGAP26, C1QR1, C5R1, CASP2, CD3G, GYPA, HBA, HBB, HMBS (PBGD), MNDA, NCFS2, and SPTB;
menstrual blood genes LEFTY2, MMPI, MMP10, and MMP11;
saliva genes HTN3, MUC7, S. mutans 16S, S. mutans proC S. mutans relA, S. mutans rplA, S. mutans rpoB, S. mutans rpoS, S. salivarius 16S, S. salivarius proC, S. salivarius relA, S. salivarius rplA, S. salivarius rpoB, S. salivarius rpoS, SMR3B, and STATH;
semen genes IZUMO1, MSP, PSA (KLK3), PRM1, PRM2, SEMG1, SEMG2, and TGM4;
skin genes CCL27, IL1F7, KRT9, LCE1C, and LCE2D;
vaginal secretion genes CYP2A7, CYP2B7P1, DKK4, FUT6, IL19, MYOZ1, and NOXO1; and
reference genes B2M, COX1, HPRT1, PGK1, PPIH, S15, TCEA1, TFRC, UBC, and UBE2D2.

10. The method of claim 1, wherein the multiplex codeset includes at least one of positive control probes and negative control probes.

11. The method of claim 10, wherein the negative control probes are used to assess background noise in the analysis.

12. The method of claim 1, wherein the gene expression log function is modelled using the following function:
log(yᵢ)˜N(log(Xβᵢ)σ²I),
wherein yᵢ is a gene expression profile for the biological sample, N is a quantity of the set of genes, X is a matrix representing the expected proportion of a plurality of genes in a plurality of biological substances, βᵢ is a vector representing amounts of all biological substances in the biological substance i, σ² is a common variance on the log scale of all genes in the plurality of genes, and I is an identity matrix.

13. The method of claim 1, wherein the maximum likelihood estimation is generated using the following function:
$${\hat{β}}_{i} = arg {min}_{β} {‖ log ( {y}_{i} ) - log ( X β ) ‖}_{2}^{2} s . t . β \geq 0.$$

14. A method for estimating the presence of substances in at least one biological sample, comprising:
determining a set of biological substances to detect within a biological sample;
for each biological substance in the set of biological substances, modelling the expression of each gene in a set of unique genes in the biological substance;
generating an expected gene proportion model using the modelled expression of each gene in the set of unique genes in the biological substance;
generating a substance model containing a quantity of each biological substance in the set of biological substances within the biological sample;
generating an expected gene expression model via using the expected gene proportion model and the substance model;
estimating gene expression in the biological sample using the expected gene expression model;
generating an estimated sample profile based on a Maximum Likelihood Estimate (MLE) of each biological substance in the set of biological substances using the estimated gene expression in the biological substance;
for each biological substance in the set of biological substances, calculating a likelihood ratio, the likelihood ratio indicating how likely the biological substance is contained in the biological sample; and
determining whether each biological substance in the set of biological substances is in the biological sample based on the calculated likelihood ratio.

15. The method of claim 14, wherein the biological sample is a tissue sample.

16. The method of claim 14, wherein each biological substance in the set of biological substances is at least one of skin, venous blood, vaginal secretion, saliva, menstrual blood, semen, and bio-particles.

17. The method of claim 14, wherein the modelled expression of each gene in the set of unique genes in each biological substance in the set of biological substances is represented as a gene expression vector for each biological substance in the set of biological substances, wherein the gene expression vector is represented as:
yᵢ=(yᵢ₁, . . . ,yᵢₚ)^{T}
wherein yᵢⱼ equals the expression of a gene j in the set of unique genes in biological substance i.

18. The method of claim 17, wherein the expected gene proportion model is an expected gene proportion matrix including each gene expression vector for each biological substance in the set of biological substances.

19. The method of claim 14, wherein the substance model is a substance vector, and
wherein the expected gene expression model is generating via multiplying the expected gene proportion model with the substance vector.

20. The method of claim 14, wherein the gene expression model is represented via the function:
log(yᵢ)˜N(log(Xβᵢ),σ²I),
wherein yᵢ is the modelled expression of each gene in the set of unique genes in each biological substance in the set of biological substances in biological sample i, N is a quantity of genes in the set of unique genes, X is the expected gene proportion model, βᵢ is a biological substance proportion model for biological sample i, is an identity matrix, and σ² is an average variance of each gene in the set of unique genes for each biological sample in the set of biological samples.

21. The method of claim 14, wherein the MLE of each biological substance in the set of biological substances is the sum of the difference between an observed gene expression for each gene in the set of unique genes for each biological sample, and an expected gene expression for each gene in the set of unique genes for each biological sample derived from the expected gene expression model.

22. The method of claim 21, wherein the MLE of each biological substance in the set of biological substances is calculated via the function:
$${\hat{β}}_{i} = arg {min}_{β} {‖ log ( {y}_{i} ) - log ( X β ) ‖}_{2}^{2} s . t . β \geq 0 ,$$
wherein \hat{β}ᵢ minimizes a sum of squared errors between the observed gene expression for each gene in the set of unique genes for each biological sample yᵢ and the expected gene expression for each gene in the set of unique genes for each biological sample Xβ when there are non-negative quantities of each biological substance in the set of biological substances.

23. The method of claim 14, wherein the likelihood ratio is represented via calculating a ratio of the likelihood of the presence of the biological substance in the biological sample and a likelihood of the absence of the biological substance in the biological sample using the function:
$$log lik ( {y}_{i} \vert {\hat{β}}_{i} ) = - \frac{1}{2} log ( det ( {σ}^{2} I ) ) - \frac{1}{2} {( log ( {y}_{i} ) - log ( X \hat{{β}_{i}} ) )}^{T} {σ}^{- 2} I ( log ( {y}_{i} ) - log ( X {\hat{β}}_{i} ) )$$
wherein the likelihood of the presence of the biological substance in the biological sample is calculated using the MLE in the function;
wherein the likelihood of the absence of the biological substance in the biological sample is calculated using a constrained MLE in the function.

24. The method of claim 23, wherein the constrained MLE is a MLE calculated when the quantity of the biological substance in the biological sample is set to zero.

25. A system configured to carry out the method of claim 1.

26. The system of claim 25, wherein the system includes a computer processor for carrying out one or more steps of the method.

27. A system configured to carry out the method of claim 14.

28. The system of claim 27, wherein the system includes a computer processor for carrying out one or more steps of the method.

29. The method of claim 21, wherein the MLE of each biological substance in the set of biological substances is calculated via the function:
S=argmin_β{∥(log(y)−log(Xβ))^{T}Σ⁻¹(log(y)−log(Xβ))∥_{P}+Penalty(β)}
wherein S is a set of MLE values for the set of biological substances in the biological sample, wherein Penalty(β) represents a further penalty on the elements of β, and wherein the function is constrained such that elements in β are non-negative.
